(19) United States
(12) Patent Application Publication
(10) Pub. No.: US 2026/0353340 A1
(43) Pub. Date: Nov. 5, 2026

(54) USER EQUIPMENT AIDED DEVICE LOCATIONING AND USER GUIDANCE

(71) Applicant: QUALCOMM Incorporated, San Diego, CA (US)

(72) Inventors: G SRIRAM, Karaikudi (IN); Akansh JAIN, Chennai (IN); Bala RAMASAMY, San Marcos, CA (US); Feliciano GOMEZ MARTINEZ, Los Gatos, CA (US); Moulshri GUPTA, Palo Alto, CA (US); Xiaoxin ZHANG, Sunnyvale, CA (US)

(21) Appl. No.: 19/195,550

(22) Filed: Apr. 30, 2025

(51) Int. Cl. H04W 64/00

(52) U.S. Cl. CPC H04W 64/00

(57) ABSTRACT

A method of wireless communication performed by a user equipment (UE) comprises, determining a location of a target object relative to a second reference frame of a secondary device, based on the location of the target object relative to a first reference frame of the UE, and a relative alignment between the first reference frame of the UE and the second reference frame of the secondary device, and sending, to the secondary device, an indication of the location of the target object relative to the second reference frame of the secondary device.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) comprises: determining a location of a target object relative to a second reference frame of a secondary device, based on: the location of the target object relative to a first reference frame of the UE; and a relative alignment between the first reference frame of the UE and the second reference frame of the secondary device; and sending, to the secondary device, an indication of the location of the target object relative to the second reference frame of the secondary device.

In an aspect, a user equipment (UE) comprises: one or more memories; one or more transceivers; and one or more processors communicatively coupled to the one or more memories and the one or more transceivers, the one or more processors, either alone or in combination, configured to: determine a location of a target object relative to a second reference frame of a secondary device, based on: the location of the target object relative to a first reference frame of the UE; and a relative alignment between the first reference frame of the UE and the second reference frame of the secondary device; and send, via the one or more transceivers, to the secondary device, an indication of the location of the target object relative to the second reference frame of the secondary device.

In an aspect, a user equipment (UE) comprises: means for determining a location of a target object relative to a second reference frame of a secondary device, based on: the location of the target object relative to a first reference frame of the UE; and a relative alignment between the first reference frame of the UE and the second reference frame of the secondary device; and means for sending, to the secondary device, an indication of the location of the target object relative to the second reference frame of the secondary device.

In an aspect, a non-transitory computer-readable medium stores computer-executable instructions that, when executed by a user equipment (UE), cause the UE to: determine a location of a target object relative to a second reference frame of a secondary device, based on: the location of the target object relative to a first reference frame of the UE; and a relative alignment between the first reference frame of the UE and the second reference frame of the secondary device; and send, to the secondary device, an indication of the location of the target object relative to the second reference frame of the secondary device.

In an aspect, a method of wireless communication performed by a secondary device comprises: receiving, from a user equipment (UE), an indication of a location of a target object relative to a reference frame of the secondary device; and indicating, via a user interface of the secondary device, one or more directions for reaching the location of the target object.

In an aspect, a secondary device comprises: one or more memories; one or more transceivers; and one or more processors communicatively coupled to the one or more memories and the one or more transceivers, the one or more processors, either alone or in combination, configured to: receive, via the one or more transceivers, from a user equipment (UE), an indication of a location of a target object relative to a reference frame of the secondary device; and indicate, via a user interface of the secondary device, one or more directions for reaching the location of the target object.

In an aspect, a secondary device comprises: means for receiving, from a user equipment (UE), an indication of a location of a target object relative to a reference frame of the secondary device; and means for indicating, via a user interface of the secondary device, one or more directions for reaching the location of the target object.

In an aspect, a non-transitory computer-readable medium stores computer-executable instructions that, when executed by a secondary device, cause the secondary device to: receive, from a user equipment (UE), an indication of a location of a target object relative to a reference frame of the secondary device; and indicate, via a user interface of the secondary device, one or more directions for reaching the location of the target object.

In an aspect, a method of wireless communication performed by a user equipment (UE) comprises: receiving, from a secondary device, secondary device information, the secondary device information comprises: one or more device parameters of the secondary device; one or more condition parameters of the secondary device; or any combination thereof; and determining whether a location of a target object should be tracked by the UE, the secondary device, or a combination thereof, based on the secondary device information and UE information, the UE information comprises: one or more device parameters of the UE; one or more condition parameters of the UE; or any combination thereof.

In an aspect, a user equipment (UE) comprises: one or more memories; one or more transceivers; and one or more processors communicatively coupled to the one or more memories and the one or more transceivers, the one or more processors, either alone or in combination, configured to: receive, via the one or more transceivers, from a secondary device, secondary device information, the secondary device information comprising: one or more device parameters of the secondary device; one or more condition parameters of the secondary device; or any combination thereof; and determine whether a location of a target object should be tracked by the UE, the secondary device, or a combination thereof, based on the secondary device information and UE information, the UE information comprising: one or more device parameters of the UE; one or more condition parameters of the UE; or any combination thereof.

In an aspect, a user equipment (UE) comprises: means for receiving, from a secondary device, secondary device information, the secondary device information comprising: one or more device parameters of the secondary device; one or more condition parameters of the secondary device; or any combination thereof; and means for determining whether a location of a target object should be tracked by the UE, the secondary device, or a combination thereof, based on the secondary device information and UE information, the UE information comprising: one or more device parameters of the UE; one or more condition parameters of the UE; or any combination thereof.

In an aspect, a non-transitory computer-readable medium stores computer-executable instructions that, when executed by a user equipment (UE), cause the UE to: receive, from a secondary device, secondary device information, the secondary device information comprising: one or more device parameters of the secondary device; one or more condition parameters of the secondary device; or any combination thereof; and determine whether a location of a target object should be tracked by the UE, the secondary device, or a combination thereof, based on the secondary device information and UE information, the UE information comprising: one or more device parameters of the UE; one or more condition parameters of the UE; or any combination thereof.

In an aspect, a method of wireless communication performed by a user equipment (UE) comprises: receiving, from a secondary device, one or more indications of a distance between the secondary device and a target object; determining a location, velocity, direction, or any combination thereof, of the target object based on: the one or more indications of the distance between the secondary device and the target object; and (i) a distance between the UE and the target object, (ii) a distance between the UE and the secondary device, or (iii) any combination thereof; and sending, to the secondary device, an indication of the location, velocity, direction, or any combination thereof, of the target object.

In an aspect, a user equipment (UE) comprises: one or more memories; one or more transceivers; and one or more processors communicatively coupled to the one or more memories and the one or more transceivers, the one or more processors, either alone or in combination, configured to: receive, via the one or more transceivers, from a secondary device, one or more indications of a distance between the secondary device and a target object; determine a location, velocity, direction, or any combination thereof, of the target object based on: the one or more indications of the distance between the secondary device and the target object; and (i) a distance between the UE and the target object, (ii) a distance between the UE and the secondary device, or (iii) any combination thereof; and send, via the one or more transceivers, to the secondary device, an indication of the location, velocity, direction, or any combination thereof, of the target object.

In an aspect, a user equipment (UE) comprises: means for receiving, from a secondary device, one or more indications of a distance between the secondary device and a target object; means for determining a location, velocity, direction, or any combination thereof, of the target object based on: the one or more indications of the distance between the secondary device and the target object; and (i) a distance between the UE and the target object, (ii) a distance between the UE and the secondary device, or (iii) any combination thereof; and means for sending, to the secondary device, an indication of the location, velocity, direction, or any combination thereof, of the target object.

In an aspect, a non-transitory computer-readable medium stores computer-executable instructions that, when executed by a user equipment (UE), cause the UE to: receive, from a secondary device, one or more indications of a distance between the secondary device and a target object; determine a location, velocity, direction, or any combination thereof, of the target object based on: the one or more indications of the distance between the secondary device and the target object; and (i) a distance between the UE and the target object, (ii) a distance between the UE and the secondary device, or (iii) any combination thereof; and send, to the secondary device, an indication of the location, velocity, direction, or any combination thereof, of the target object.

In an aspect, a method of wireless communication performed by a secondary device comprises: sending, to a user equipment (UE), one or more indications of a distance between the secondary device and a target object; and receiving, from the UE, an indication of a location, velocity, direction, or any combination thereof, of the target object; indicating, via a user interface of the secondary device, one or more directions for reaching the target object.

In an aspect, a secondary device comprises: one or more memories; one or more transceivers; and one or more processors communicatively coupled to the one or more memories and the one or more transceivers, the one or more processors, either alone or in combination, configured to: send, via the one or more transceivers, to a user equipment (UE), one or more indications of a distance between the secondary device and a target object; and receive, via the one or more transceivers, from the UE, an indication of a location, velocity, direction, or any combination thereof, of the target object; indicate, via a user interface of the secondary device, one or more directions for reaching the target object.

In an aspect, a secondary device comprises: means for sending, to a user equipment (UE), one or more indications of a distance between the secondary device and a target object; and means for receiving, from the UE, an indication of a location, velocity, direction, or any combination thereof, of the target object; means for indicating, via a user interface of the secondary device, one or more directions for reaching the target object.

In an aspect, a non-transitory computer-readable medium stores computer-executable instructions that, when executed by a secondary device, cause the secondary device to: send, to a user equipment (UE), one or more indications of a distance between the secondary device and a target object; and receive, from the UE, an indication of a location, velocity, direction, or any combination thereof, of the target object; indicate, via a user interface of the secondary device, one or more directions for reaching the target object.

In an aspect, a method of wireless communication performed by a user equipment (UE) comprises: sensing an environment of the UE to obtain sensing information; and sending instructions, directions, or any combination thereof to a secondary device based on the sensing information. A method of wireless communication performed by a user equipment (UE) comprises: determining that a secondary device communicates with a user via a first communication type of a plurality of communication types; determining to switch to a second communication type of the plurality of communication types, based on: a behavior of the user; an environment of the user; a condition of the secondary device; or any combination thereof; and sending an indication of the second communication type.

In an aspect, a user equipment (UE) comprises: one or more memories; one or more transceivers; and one or more processors communicatively coupled to the one or more memories and the one or more transceivers, the one or more processors, either alone or in combination, configured to: sense an environment of the UE to obtain sensing information; and send, via the one or more transceivers, instructions, directions, or any combination thereof to a secondary device based on the sensing information. A user equipment (UE) comprises: one or more memories; one or more transceivers; and one or more processors communicatively coupled to the one or more memories and the one or more transceivers, the one or more processors, either alone or in combination, configured to: determine that a secondary device communicates with a user via a first communication type of a plurality of communication types; determine to switch to a second communication type of the plurality of communication types, based on: a behavior of the user; an environment of the user; a condition of the secondary device; or any combination thereof; and send, via the one or more transceivers, an indication of the second communication type.

In an aspect, a user equipment (UE) comprises: means for sensing an environment of the UE to obtain sensing information; and means for sending instructions, directions, or any combination thereof to a secondary device based on the sensing information. A user equipment (UE) comprises: means for determining that a secondary device communicates with a user via a first communication type of a plurality of communication types; means for determining to switch to a second communication type of the plurality of communication types, based on: a behavior of the user; an environment of the user; a condition of the secondary device; or any combination thereof; and means for sending an indication of the second communication type.

In an aspect, a non-transitory computer-readable medium stores computer-executable instructions that, when executed by a user equipment (UE), cause the UE to: sense an environment of the UE to obtain sensing information; and send instructions, directions, or any combination thereof to a secondary device based on the sensing information. A non-transitory computer-readable medium stores computer-executable instructions that, when executed by a user equipment (UE), cause the UE to: determine that a secondary device communicates with a user via a first communication type of a plurality of communication types; determine to switch to a second communication type of the plurality of communication types, based on: a behavior of the user; an environment of the user; a condition of the secondary device; or any combination thereof; and send an indication of the second communication type.

In an aspect, a method of wireless communication performed by a secondary device comprises: communicating with a user of the secondary device via a first communication type of a plurality of communication types; receiving an indication of a second communication type of the plurality of communication types; and communicating with the user of the secondary device via the second communication type based on the indication.

In an aspect, a secondary device comprises: one or more memories; one or more transceivers; and one or more processors communicatively coupled to the one or more memories and the one or more transceivers, the one or more processors, either alone or in combination, configured to: communicate with a user of the secondary device via a first communication type of a plurality of communication types; receive, via the one or more transceivers, an indication of a second communication type of the plurality of communication types; and communicate with the user of the secondary device via the second communication type based on the indication.

In an aspect, a secondary device comprises: means for communicating with a user of the secondary device via a first communication type of a plurality of communication types; means for receiving an indication of a second communication type of the plurality of communication types; and means for communicating with the user of the secondary device via the second communication type based on the indication.

In an aspect, a non-transitory computer-readable medium stores computer-executable instructions that, when executed by a secondary device, cause the secondary device to: communicate with a user of the secondary device via a first communication type of a plurality of communication types; receive an indication of a second communication type of the plurality of communication types; and communicate with the user of the secondary device via the second communication type based on the indication.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates an example Long-Term Evolution (LTE) positioning protocol (LPP) capability transfer procedure, assistance data transfer procedure, and location information transfer procedure between a target device and a location server, according to aspects of the disclosure.

FIG. 5 illustrates examples of various positioning methods supported in New Radio (NR), according to aspects of the disclosure.

FIG. 6 illustrates an environment for user interactions by a user associated with a user equipment (UE) and one or more secondary devices, according to aspects of the disclosure.

FIG. 7 illustrates a flowchart for operating a system of complementary devices, according to aspects of the disclosure.

FIG. 8 illustrates an example of reference frame alignment, according to aspects of the disclosure.

FIG. 9 illustrates an example of reference frame alignment, according to aspects of the disclosure.

FIG. 10 illustrates an example of instructions and guidance associated with a secondary device, according to aspects of the disclosure.

FIG. 11 illustrates an example of resource allocation, according to aspects of the disclosure.

FIG. 12 illustrates an example of combining ranging from multiple devices, according to aspects of the disclosure.

FIG. 13 illustrates an example of multi-device tracking, according to aspects of the disclosure.

FIG. 14 illustrates an example of optimal and/or efficient allocation of resources, according to aspects of the disclosure.

FIGS. 15 to 21 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to device positioning and/or locationing. Some aspects more specifically relate to positioning and/or locationing associated with a user equipment (UE) and one or more secondary devices. A user may carry a UE (e.g., primary device such as a smartphone) and one or more secondary devices (e.g., smartwatch, augmented reality (AR) glasses, etc.). In some examples, the devices may have different capabilities and limitations. The devices may be equipped to facilitate location-based applications (e.g., locating a vehicle, navigating to a destination, or tracking a lost device). However, due to the varied capabilities and limitations, it can be challenging to ensure the best user experience. For example, AR glasses may be a better user interface for a vehicle-location application, but may lack processing power and battery. The smartphone may have ample processing power and battery, but the user interface of the smartphone is less suitable for guiding the user to the vehicle location.

Particular aspects of the subject matter described in this disclosure can be implemented to realize one or more of the following potential advantages.

In some examples, based on a location of the target object relative to a first reference frame of the UE and a relative alignment between the first reference frame of the UE and a second reference frame of the secondary device, a UE may determine a location of a target object relative to a second reference frame of a secondary device. By determining the location relative to the second reference frame, and sending, to the secondary device, an indication of the location of the target object relative to the second reference frame of the secondary device, the described techniques can be used to offload operations for location-based applications from a secondary device to a primary device (e.g., a device with greater processing power, more battery resources, etc.).

In some examples, by determining whether a location of a target object should be tracked by the UE, the secondary device, or a combination thereof, based on secondary device information and UE information, the described techniques can be to optimize resource allocation. For example, the described techniques can be used to offload operations for location-based applications from a secondary device to a primary device (e.g., a device with greater processing power, more battery resources, etc.).

In some examples, by receiving, from a secondary device, one or more indications of a distance between the secondary device and a target object, determining a location, velocity, direction, or any combination thereof, of the target object, and sending, to the secondary device, an indication of the location, velocity, direction, or any combination thereof, of the target object, the described techniques can be used to combine ranging capabilities of multiple devices to determine a distance to the target object more accurately and/or more efficiently.

In some examples, by sensing an environment of the UE to obtain sensing information and sending instructions, directions, or any combination thereof to a secondary device based on the sensing information, the described techniques can be used to perform sensing-aided guidance.

In some examples, by determining that a secondary device communicates with a user via a first communication type of a plurality of communication types, determining to switch to a second communication type of the plurality of communication types, based on a behavior of the user, an environment of the user, a condition of the secondary device, or any combination thereof, and sending an indication of the second communication type, the described techniques can be used to implement an adaptive feedback mode. For example, the described techniques can be used to communicate with a user more accurately and/or more effectively.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

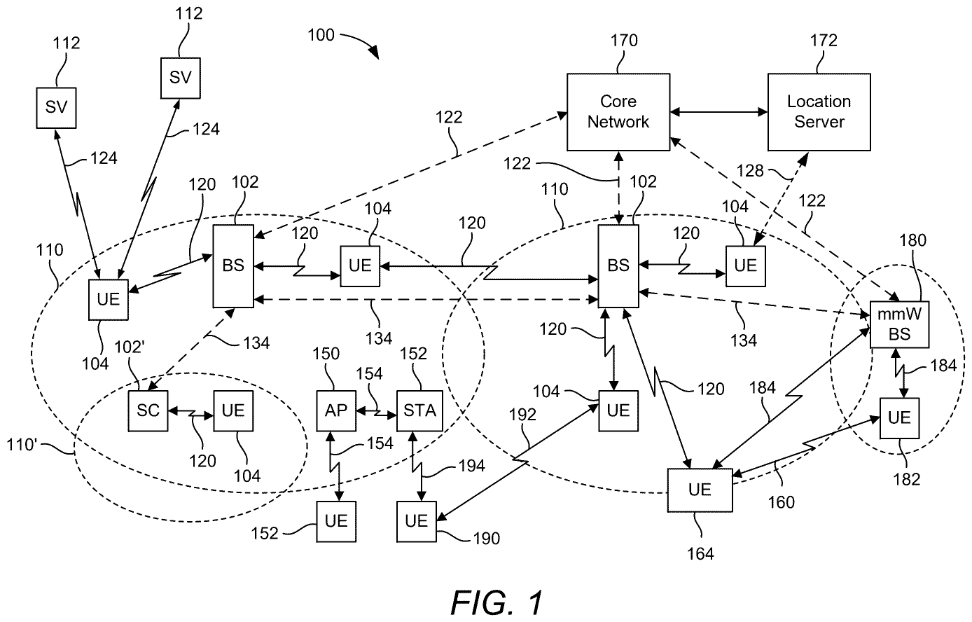

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102', access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

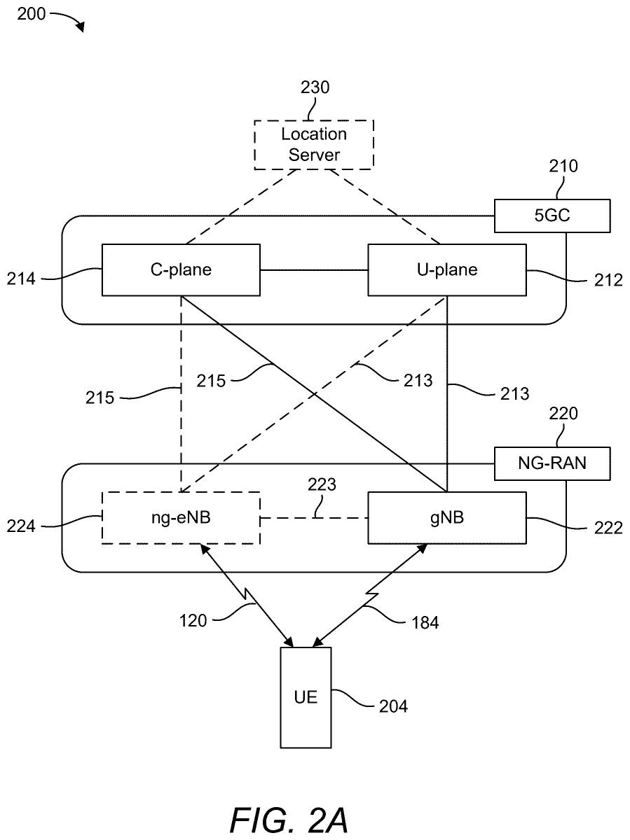

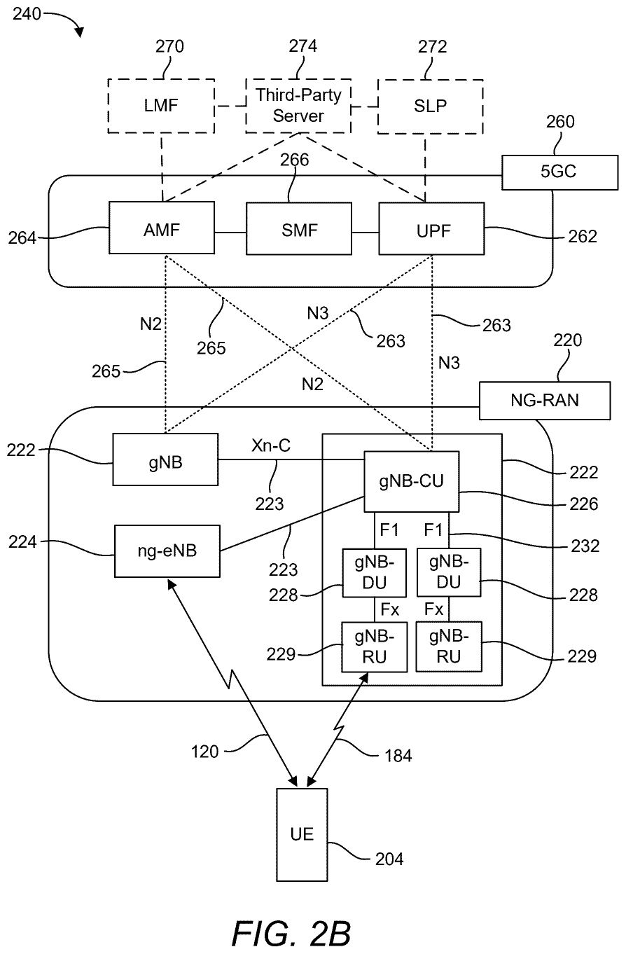

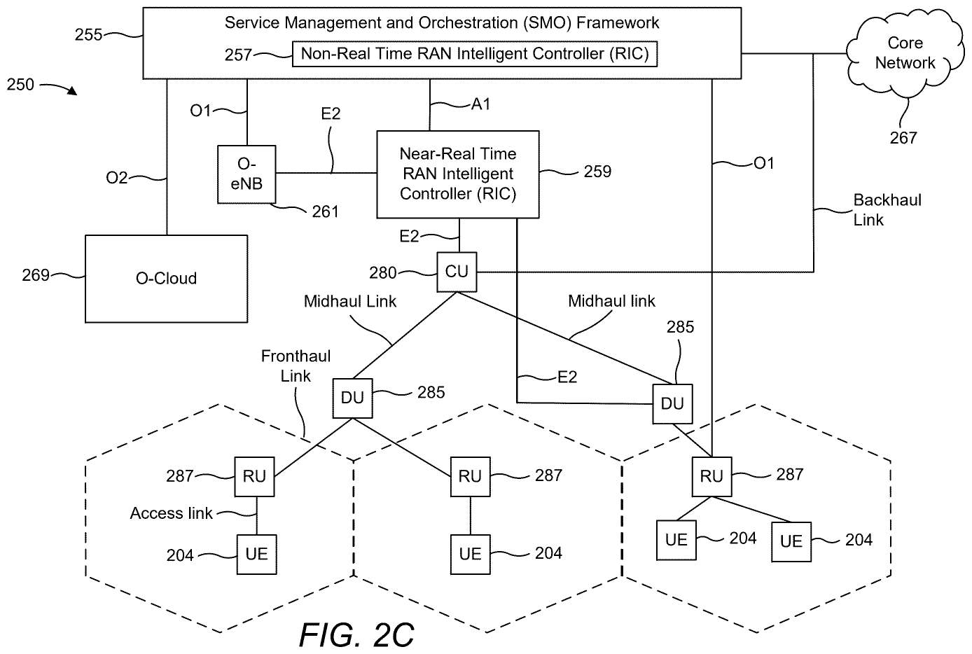

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

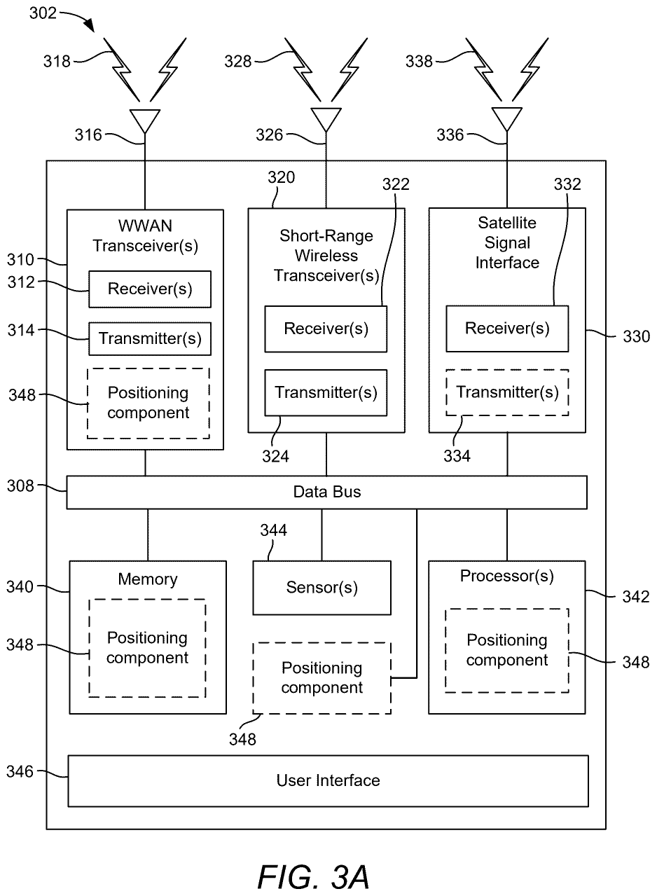

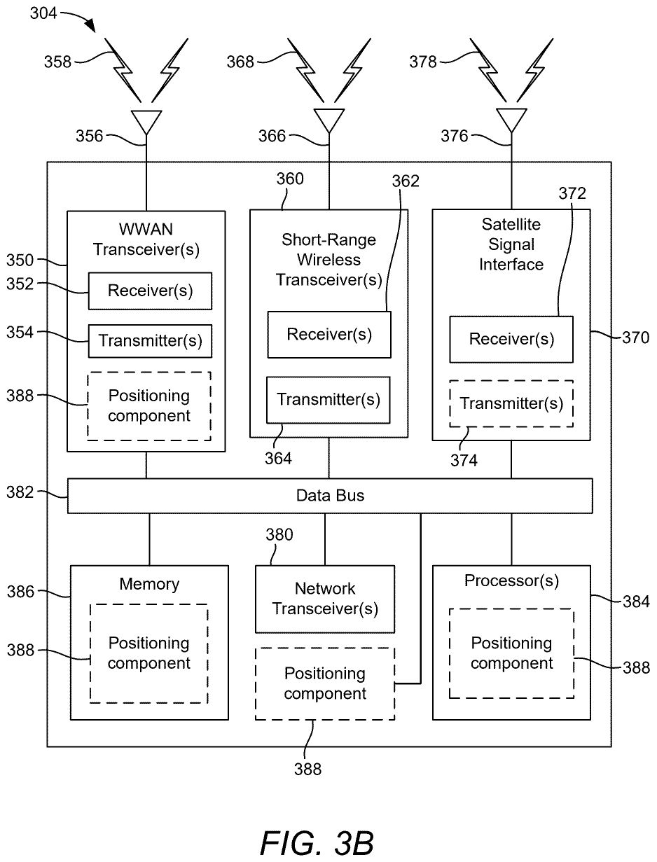

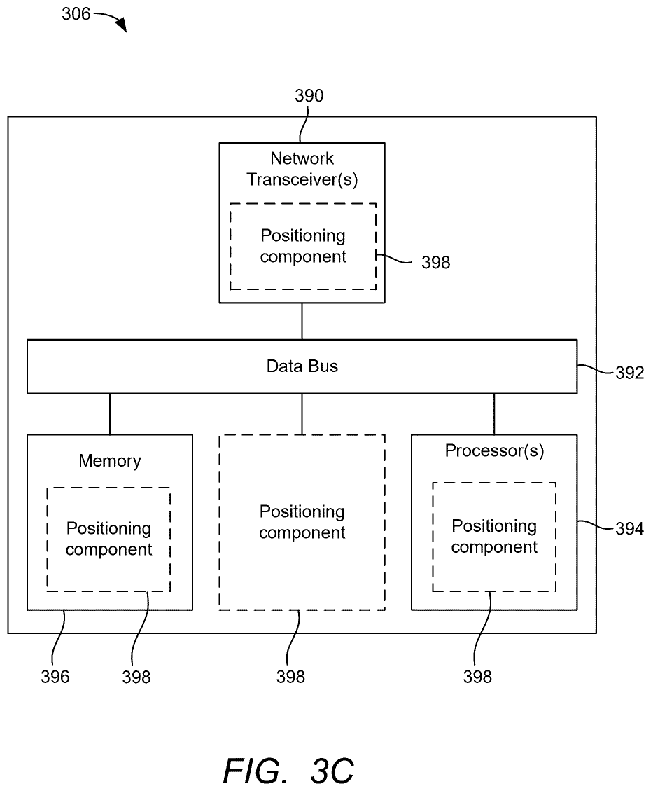

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 348, 388, and 398, respectively. The positioning component 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the positioning component 348, 388, and 398 may be external to the processors 342, 384, and 394 (e.g., part of a modem processing system, integrated with another processing system, etc.). Alternatively, the positioning component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the positioning component 348, which may be, for example, part of the one or more WWAN transceivers 310, the memory 340, the one or more processors 342, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the positioning component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

Long-Term Evolution (LTE) positioning protocol (LPP) may be used point-to-point between a location server (e.g., LMF 270) and a target device (e.g., a UE) in order to position the target device using position-related measurements obtained by one or more reference sources (physical entities or parts of physical entities that provide signals that can be measured by a target device in order to obtain the location of the target device). An LPP session may be used between a location server and a target device in order to obtain location-related measurements or a location estimate or to transfer assistance data. Currently, a single LPP session may be used to support a single location request and multiple LPP sessions can be used between the same endpoints to support multiple different location requests. Each LPP session comprises one or more LPP transactions (or procedures), with each LPP transaction performing a single operation (capability exchange, assistance data transfer, or location information transfer). Each LPP transaction involves the exchange of one or more LPP messages between the location server and the target device. The general format of an LPP message consists of a set of common fields followed by a body. The body (which may be empty) contains information specific to a particular message type. Each message type contains information specific to one or more positioning methods and/or information common to all positioning methods.

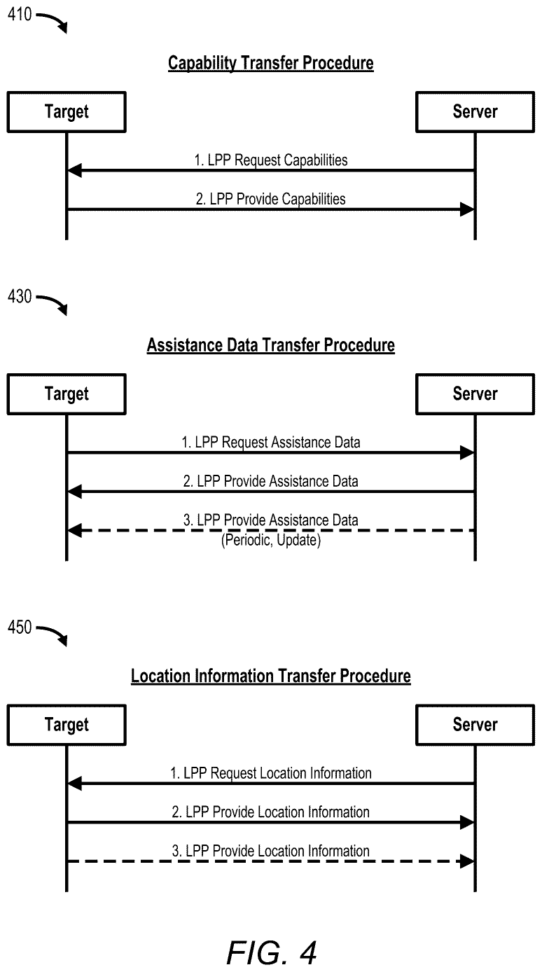

An LPP session generally includes at least a capability transfer or indication procedure, an assistance data transfer or delivery procedure, and a location information transfer or delivery procedure. FIG. 4 illustrates an example LPP capability transfer procedure 410, LPP assistance data transfer procedure 430, and LPP location information transfer procedure 450 between a target device (labeled “Target”) and a location server (labeled “Server”), according to aspects of the disclosure.

The purpose of an LPP capability transfer procedure 410 may be to enable the transfer of capabilities from the target device (e.g., a UE 204) to the location server (e.g., an LMF 270). Capabilities in this context refer to positioning and protocol capabilities related to LPP and the positioning methods supported by LPP. In the LPP capability transfer procedure 410, the location server (e.g., an LMF 270) indicates the types of capabilities needed from the target device (e.g., UE 204) in an LPP Request Capabilities message. The target device responds with an LPP Provide Capabilities message. The capabilities included in the LPP Provide Capabilities message should correspond to any capability types specified in the LPP Request Capabilities message. Specifically, for each positioning method for which a request for capabilities may be included in the LPP Request Capabilities message, if the target device supports this positioning method, the target device includes the capabilities of the target device for that supported positioning method in the LPP Provide Capabilities message. For an LPP capability indication procedure, the target device provides unsolicited (i.e., without receiving an LPP Request Capabilities message) capabilities to the location server in an LPP Provide Capabilities message.

The purpose of an LPP assistance data transfer procedure 430 may be to enable the target device to request assistance data from the location server to assist in positioning, and to enable the location server to transfer assistance data to the target device in the absence of a request. In the LPP assistance data transfer procedure 430, the target device sends an LPP Request Assistance Data message to the location server. The location server responds to the target device with an LPP Provide Assistance Data message containing assistance data. The transferred assistance data should match or be a subset of the assistance data requested in the LPP Request Assistance Data. The location server may also provide any not requested information that it considers useful to the target device. The location server may also transmit one or more additional LPP Provide Assistance Data messages to the target device containing further assistance data. For an LPP assistance data delivery procedure, the location server provides unsolicited assistance data necessary for positioning. The assistance data may be provided periodically or non-periodically.

The purpose of an LPP location information transfer procedure 450 may be to enable the location server to request location measurement data and/or a location estimate from the target device, and to enable the target device to transfer location measurement data and/or a location estimate to a location server in the absence of a request. In an LPP location information transfer procedure 450, the location server sends an LPP Request Location Information message to the target device to request location information, indicating the type of location information needed and potentially the associated QoS. The target device responds with an LPP Provide Location Information message to the location server to transfer location information. The location information transferred should match or be a subset of the location information requested by the LPP Request Location Information unless the location server explicitly allows additional location information. For example, more specifically, if the requested information is compatible with the target device's capabilities and configuration, the target device includes the requested information in an LPP Provide Location Information message. Otherwise, if the target device does not support one or more of the requested positioning methods, the target device continues to process the message as if it contained only information for the supported positioning methods and handles the signaling content of the unsupported positioning methods by LPP error detection. If requested by the LPP Request Location Information message, the target device sends additional LPP Provide Location Information messages to the location server to transfer additional location information. An LPP location information delivery procedure supports the delivery of positioning estimations based on unsolicited service.

LPP also defines procedures related to error indication for when a receiving endpoint (target device or location server) receives erroneous or unexpected data or detects that certain data are missing. Specifically, when a receiving endpoint determines that a received LPP message contains an error, it can return an Error message to the transmitting endpoint indicating the error or errors and discard the received/erroneous message. For example, if the receiving endpoint is able to determine that the erroneous LPP message is an LPP Error or Abort Message, then the receiving endpoint discards the received message without returning an Error message to the transmitting endpoint.

LPP also defines procedures related to abort indication to allow a target device or location server to abort an ongoing procedure due to some unexpected event (e.g., cancellation of a location request by an LCS client). An Abort procedure can also be used to stop an ongoing procedure (e.g., periodic location reporting from the target device). In an Abort procedure, a first endpoint determines that procedure P must be aborted and sends an Abort message to a second endpoint carrying the transaction ID for procedure P. The second endpoint then aborts procedure P.

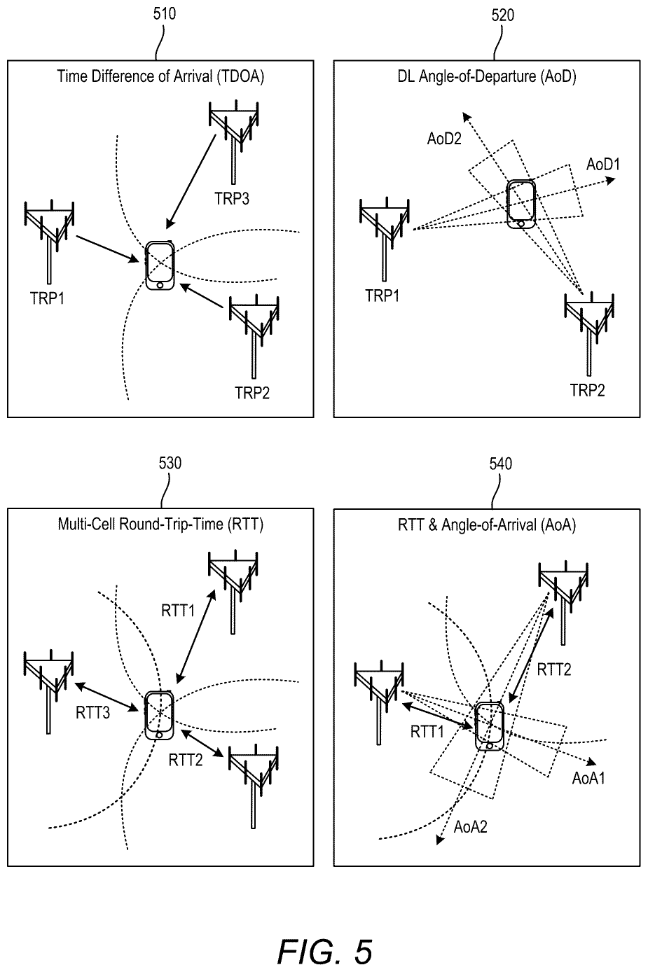

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 5 illustrates examples of various positioning methods, according to aspects of the disclosure. In an OTDOA or DL-TDOA positioning procedure, illustrated by scenario 510, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 520, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference may be referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 530, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 540.

The E-CID positioning method may be based on radio resource management (RRM) measurements. In E-CID, the UE reports the serving cell ID, the timing advance (TA), and the identifiers, estimated timing, and signal strength of detected neighbor base stations. The location of the UE may be estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32μs. In other cases, when all of the resources used for the positioning measurement(s) are in FR2, the value range for the uncertainty of the expected RSTD may be +/−8μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

A collection of resource elements (REs) that are used for transmission of PRS is referred to as a “PRS resource.” An RE may comprise a block of one symbol in the time domain and one subcarrier in the frequency domain. The collection of resource elements can span multiple physical resource blocks (PRBs) in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS.

Currently, a DL-PRS resource may span 2, 4, 6, or 13 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 13 over 2, 4, 6, and 13 symbols. 2-symbol comb-2: {0, 1}; 4-symbol comb-2: {0, 1, 0, 1}; 6-symbol comb-2: {0, 1, 0, 1, 0, 1}; 13-symbol comb-2: {0, 1, 0, 1, 0, 1, 0, 1, 0, 1, 0, 1}; 4-symbol comb-4: {0, 2, 1, 3}; 13-symbol comb-4: {0, 2, 1, 3, 0, 2, 1, 3, 0, 2, 1, 3}; 6-symbol comb-6: {0, 3, 1, 4, 2, 5}; 13-symbol comb-6: {0, 3, 1, 4, 2, 5, 0, 3, 1, 4, 2, 5}; and 13-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1380, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance,” a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

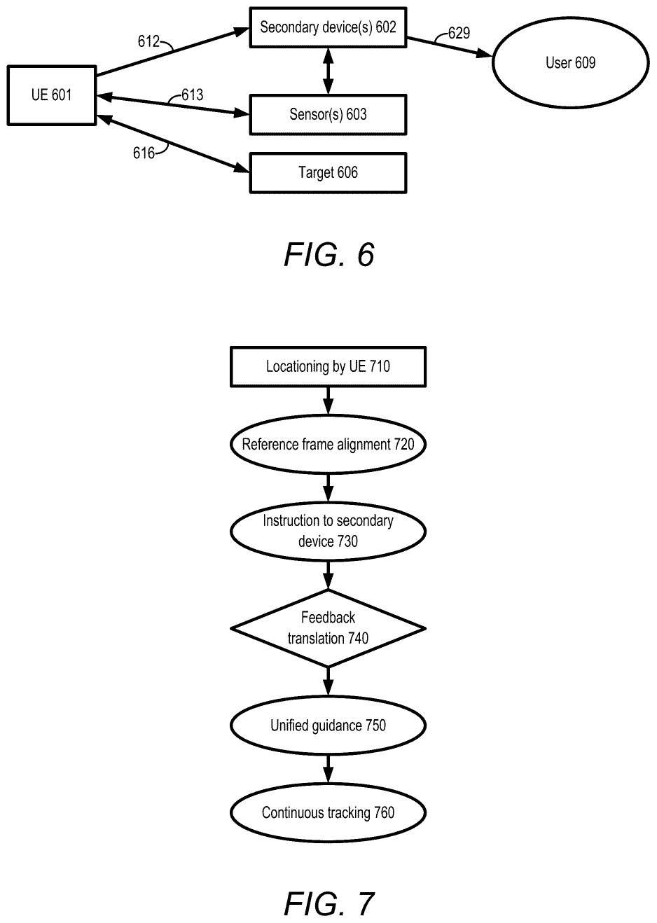

FIG. 6 is a graph 600 representing an example channel estimate of a multipath channel between a receiver device (e.g., any of the UEs or base stations described herein) and a transmitter device (e.g., any other of the UEs or base stations described herein), according to aspects of the disclosure. The channel estimate represents the intensity of a radio frequency (RF) signal (e.g., a positioning reference signal (PRS)) received through a multipath channel as a function of time delay, and may be referred to as the channel energy response (CER), channel impulse response (CIR), or power delay profile (PDP) of the channel. Thus, the horizontal axis represents time (e.g., milliseconds) and the vertical axis represents signal strength (e.g., decibels). Note that a multipath channel is a channel between a transmitter and a receiver over which an RF signal follows multiple paths, or multipaths, due to transmission of the RF signal on multiple beams and/or to the propagation characteristics of the RF signal (e.g., reflection, refraction, etc.).

In the example of FIG. 6, the receiver detects/measures multiple (four) channel taps of the RF signal. Each channel tap is a cluster of one or more rays and corresponds to a multipath that the RF signal followed between the transmitter and the receiver. Thus, a channel tap represents the time of arrival and signal strength of an RF signal over a multipath. There may be multiple channel taps due to the RF signal being transmitted on different transmit beams (and therefore at different angles), or because of the propagation characteristics of RF signals (e.g., potentially following different paths due to reflections), or both. Note that although FIG. 6 illustrates channel taps of two to five rays, as will be appreciated, the channel taps may have more or fewer than the illustrated number of rays.

In the example of FIG. 6, the channel tap detected at time T3 is composed of stronger rays than the channel tap detected at time T1. This may be due to an obstruction on the LOS path between the transmitter and the receiver. Alternatively or additionally, there may be a strong reflector along the NLOS path corresponding to the channel tap detected at time T3.

In an example, the UE measures, determines, and/or reports a channel frequency response (CFR) based on one or more received PRSs. A CFR may be obtained by applying a channel estimation in a frequency domain based on a PRS sequence. The PRS sequence may be mapped to one or more orthogonal frequency-division multiplexing (OFDM) signals.

In an example, the UE measures, determines, and/or reports a channel impulse response (CIR) based on one or more received PRSs. The CIR may be composed of a list of measurements, where each measurement contains delay, power, and phase information. The CIR may be obtained by applying an inverse fast Fourier transform to a CFR. Delay, power, and/or phase information may be derived from the inverse fast Fourier transform. The UE may apply truncation to the CIR and report a truncated CIR.

In an example, the UE measures, determines, and/or reports a power delay profile (PDP) based on one or more received PRSs. The PDP may be composed of a list of measurements, where each measurement contains delay and power information. The PDP may be equal to an absolute value of a CIR. The UE may apply truncation to the PDP and report a truncated PDP.

In an example, the UE measures, determines, and/or reports a delay profile (DP) based on one or more received PRSs. The DP may be composed of a list of measurements, where each measurement contains delay information. DP can correspond to timing info of CIR/PDP measurements with significant power/peak info or can correspond to plurality of time info that are derived from CIR/PDP. The UE may apply truncation to the DP and report a truncated DP.

FIG. 6 illustrates an environment for user interactions by a user associated with a user equipment (UE) and one or more secondary devices, according to aspects of the disclosure. In the illustration are a UE 601 (e.g., a primary device such as a smartphone), one or more secondary devices 602, one or more sensors 603, a target 606, and a user 690.

As in the scenario of FIG. 6, user 690 may have multiple device for assisting the user with multiple applications. UE 601 may be considered as a primary device based on its power and versatility relative to the one or more secondary devices 602.

Although it is powerful and versatile, UE 601 may have other limitations. For example, when navigating a user to a specific location or object using UE 601, the user may be constantly looking at their phone. This may be a distracting and unsafe option. Traditional navigation methods require visual attention, which can be inconvenient and reduce situational awareness.

The one or more secondary devices 602 may be less powerful and less versatile, but may offer advantages. For example, the one or more secondary devices 602 may be easier to access than the UE 601.

Examples of the one or more secondary devices 602 may include a smartwatch, augmented reality (AR) glasses, fitness trackers, one or more earphones (e.g., a pair of earphones), one or more headphones (e.g., a pair of headphones), etc. Many secondary device may be worn on the body (e.g., on the wrist or over the eyes), making them more accessible, in many scenarios, than the primary device (e.g., UE 601). The accessibility of these secondary devices may be leveraged for various secondary applications that benefit from increased accessibility, such as locating a vehicle, navigating to a destination, or tracking a lost device. Some secondary devices may have particular advantages relative to other secondary devices and the primary device. For example, visually-impaired users face significant challenges in navigation and locating objects, relying heavily on auditory cues which can be less effective in noisy environments. In such a scenario, secondary devices that can provide auditory outputs may significantly improve user experience relative to UE 601 or to other secondary devices that rely on visual outputs.

As noted above, the one or more secondary devices 602 may have drawbacks and limitations relative to UE 601. For example, the one or more secondary devices 602 may not have ranging capabilities of the UE 601 (e.g., due to lack of advanced radio access technologies and/or sensors needed for precise distance measurement, making it difficult to accurately locate targets).

As another example, the one or more secondary devices 602 may have power constraints. For example, the one or more secondary devices 602 may have small batteries which do not support sustained power-intensive tasks for long periods (e.g., continuous tracking of a peer device, target, and/or location).

As another example, the one or more secondary devices 602 may have a limited range of coverage. For example, limited connectivity can hinder the ability of the one or more secondary devices 602 to range over long distances, reducing their effectiveness in large areas.

As another example, the one or more secondary devices 602 may have limited processing power, which may limit their ability to handle certain signal processing algorithms for accurate locationing.

For some tasks, the one or more secondary devices 602 may have equal, or even greater, capabilities relative to UE 601. For example, although some secondary devices may have small batteries and few sensors, others may be well-equipped to support locationing. In some scenarios, such devices may supplant the UE 601 for tracking tasks. Moreover, even a secondary device with low capabilities may be able to augment the tasks that are (primarily) performed by UE 601 or other secondary devices.

In accordance with aspects of the disclosure, the strengths of both primary and secondary devices may be leveraged to address the aforementioned challenges. The primary and secondary devices may operate as a system of complementary devices. As an example, UE 601 may handle location tracking and processing (e.g., more demanding tasks that leverage the power and versatility of UE 601), while the secondary device can provide the user with real-time guidance and feedback (e.g., tasks that benefit from a more accessible user interface).

The system of complementary devices may assist user 690 by providing directional assistance. For example, UE 601 may calculate a precise location of a target 606 (e.g., a vehicle). UE 601 may have greater locationing capabilities than the one or more secondary devices 602 due to having a more advanced radio access technology (RAT), more sensors, a greater store of power, or any combination thereof. UE 601 may apply its locationing capabilities to perform a locationing 616 of the target 606. The 616 may be based on a reference frame 613 associated with one or more sensors 603. UE 601 may send instructions 612 (e.g., directional information) to the one or more secondary devices 602 based on the timer starting at 616 of the target 606. The secondary device may be, for example, a smartwatch. The smartwatch may provide feedback 629 (e.g., walking directions) to user 690 via a user interface (e.g., a front face of the smartwatch). The user interface of the smartwatch may be more accessible than the user interface of UE 601 (e.g., less likely to cause a distraction to user 690). In this example, the accessibility of the one or more secondary devices 602 (e.g., the smartwatch) complement the power and locationing capabilities of UE 601.

As another example, the one or more secondary devices 602 may provide guidance to user 690 by displaying step-by-step instructions or visual cues. AR glasses, for example, may overlay arrows on a field of vision of user 690 to guide user 690 to a destination. Secondary devices may also use vibrations or other tactile signals to provide discreet guidance. For example, a smartwatch might vibrate once to indicate a left turn, twice for a right turn, and continuously to signal a wrong direction. As another example, the haptic feedback might indicate a direction to the user, haptic feedback towards left, haptic feedback towards right, etc. Earbuds or other auditory devices may provide auditory guidance. For instance, one beep may indicate to turn left, two beeps may indicate to turn right, and continuous beeping may indicate that user 690 is going in the wrong direction. Additionally, a sound location instruction can indicate a desired direction of movement (e.g., left, right, forward, etc.). In a system of complementary devices, any device may apply its advantages to complete a particular task, and the sum of the tasks-each performed by a suitable device-may provide user 690 with a high quality user experience.

In accordance with aspects of the disclosure, the aforementioned problems may be addressed by using primary device aided locationing and an adaptive feedback system. The techniques disclosed herein may be implemented with any device that can be used for location and sensing applications. The applications could be locating a target device, providing directions to a destination, finding the proximity of a target device using a secondary device, or other implementations of primary device aided locationing and adaptive feedback.

FIG. 7 illustrates a flowchart for operating a system of complementary devices, according to aspects of the disclosure. The operations illustrated in FIG. 7 may be performed by a UE and/or primary device (e.g., such as UE 601 or any other UE described in the present disclosure).

At 710, the UE may perform locationing. For example, the UE may determine directionality and/or calculate distance. The UE may use one or more RATs (e.g., wireless local area network (WLAN), Wi-Fi, Bluetooth low energy (BLE), ultra wideband (UWB), etc., to determine the direction and distance to the target.

At 720, the UE may align a reference frame. For example, the UE may determine its orientation relative to a secondary device (e.g., at least one of the one or more secondary devices 602). To perform the alignment, the UE may use one or more RATS and/or sensors associated with the UE, the secondary device, one or more other secondary devices, or any combination thereof. For example, the UE may request and/or receive, and the secondary device may send, real-time sensor data (e.g., data from an inertial measurement unit (IMU), camera, etc.). The UE may align a reference frame of the UE with a reference frame of the secondary device by comparing IMU data trends over time (e.g., IMU data of the UE, IMU data of the secondary device, or any combination thereof). In an example, the UE may compare IMU data trends over time, rather than instant changes, to account for head movements and arm swings.

At 730, the UE may provide an instruction to the secondary device. The instruction may be, for example, initial guidance. The instruction may be, for example, a positional instruction. The UE may translate directionality and distance from the reference frame of the UE into the reference frame of the secondary device. The translation may be based on the reference frame alignment 720.

At 740, the UE and/or secondary device provides instructions and/or guidance to the user (e.g., similar to user 690) through at least one type of feedback (e.g., visual, haptic, and/or auditory signals). The secondary device may provide the instructions and/or guidance to the user based on the instruction received from the UE. Additionally or alternatively, the secondary device may provide the instructions and/or guidance to the user via the secondary device.

At 750, the UE and/or secondary device provides unified guidance to the user. For example, the UE (e.g., smartphone) may display visual arrows. Additionally or alternatively, a secondary device (e.g., a smartwatch) may provide haptic feedback. Additionally or alternatively, another secondary device (e.g., AR glasses) may provide visual and sound guidance. In some implementations, the unified guidance may comprise simultaneous guidance from different device (e.g., UE and secondary device) which guide the user to a single target.

At 760, the UE and/or secondary devices provide continuous tracking and adjustment. The UE and the secondary devices may separately and/or jointly track and adjust for precise locationing continuously. For example, a smartwatch may use its IMU to compensate for arm swing motion, and maintain accurate haptic feedback. The UE may periodically recalibrate the alignment of the reference frames to correct for IMU drift.

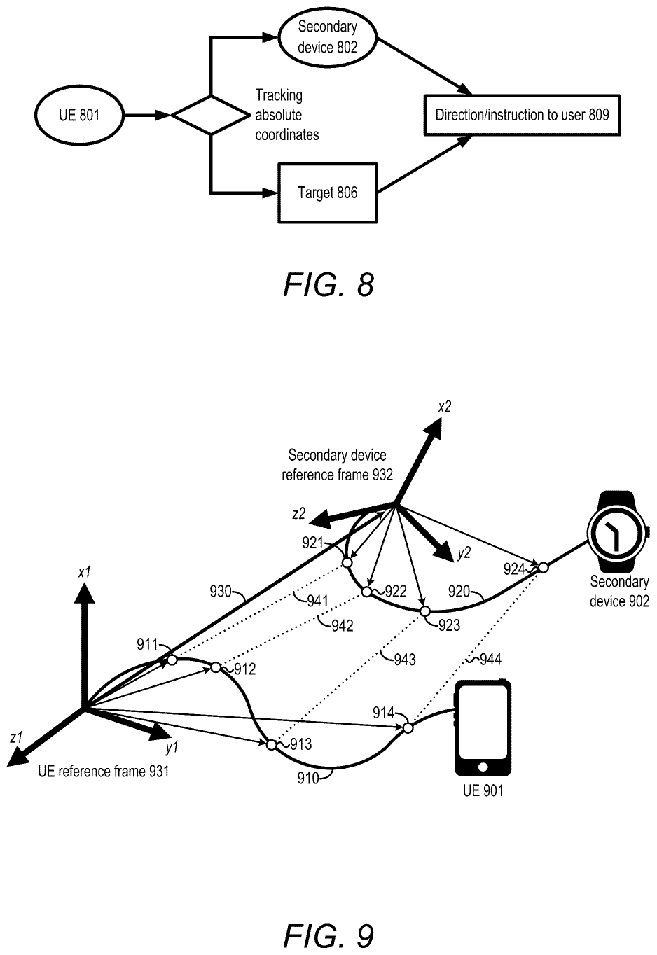

FIG. 8-9 illustrate examples of reference frame alignment, according to aspects of the disclosure. FIG. 8 illustrates a UE 801, one or more secondary devices 802, a target 806, and a direction and/or instruction to user 809. FIG. 9 illustrates a UE 901 and a secondary device 902. The UE 801 and UE 901 may correspond to the UE 601 or any of the other UEs of the present disclosure. The one or more secondary devices 802 and secondary device 902 may be correspond to any of the one or more secondary devices 602 or any of the other secondary devices of the present disclosure.

As noted above, a system of complementary devices may comprise a primary device (e.g., UE 801 and/or UE 901) and at least one secondary devices (e.g., the secondary device 802 and/or secondary device 902). The reference frame of the primary device may differ from the reference frame of the secondary device. For example, the primary device may have a different position and orientation from the secondary device. Moreover, the relative position and relative orientation of the two devices may change over time.

As shown in FIG. 8, UE 801 may map and translate the location(s) of the one or more secondary devices 802 and a target 806. For example, UE 801 may determine a position of target 806. The position may be associated with absolute coordinates (e.g., latitude, longitude, and/or elevation). The secondary device 802 may provide a direction and/or instruction to user 809. Additionally or alternatively, UE 801 may provide the direction and/or instruction to user 809 via secondary device 802 (e.g., via at least one user interface associated with the one or more secondary devices 802). Additionally or alternatively, secondary device 802 may provide the direction and/or instruction to user 809 based on commands and/or instructions received from UE 801.

As an example, UE 801 may determine a relative difference between the reference frame of the primary device and the reference frame of the secondary device. UE 801 may obtain the position of target 806 as an absolute coordinates. UE 801 may translate, based on the relative difference between the reference frame of the primary device and the reference frame of the secondary device, the absolute coordinates. UE 801 may translate the absolute coordinates into relative coordinates. The translated coordinates may be relative to the reference frame of the secondary device 802. Based on the relative coordinates, secondary device 802 may provide the direction and/or instruction to user 809.

As an example, a user carries UE 801 (e.g., in a pocket of the user) and wears a secondary device (e.g., AR glasses). The AR glasses are disposed two feet higher in elevation than the UE 801. Moreover, the AR glasses are pointed straight ahead, relative to the perspective of the user, whereas the UE 801 is oriented ninety degrees to the left of the user. The UE 801 may determine that target 806 is ten feet directly to the right of UE 801, at the same elevation as UE 801.

Based on the relative difference between the reference frame of UE 801 and the reference frame of the AR glasses, UE 801 may translate the coordinates of target 806 (e.g., so that the position of target 806 is correctly displayed on the AR glasses). Based on the ninety-degree difference in orientation, UE 801 translates the direction of target 806 by ninety degrees. Based on the elevation difference between UE 801 and the AR glasses, UE 801 translates the elevation of target 806 two feet downward. UE 801 may send the coordinates (e.g., translated coordinates relative to the reference frame of the AR glasses) to the AR glasses. The coordinates may indicate that target 806 is ten feet ahead and two feet downward. The AR glasses may indicate to the user, in any suitable manner, that target 806 is ten feet ahead and two feet downward.

As an example, in certain indoor scenarios, UE 801 can ascertain the absolute coordinates of both target 806 and secondary device 802. This may be achieved using round trip time (RTT) and angle-of-arrival (AoA), and/or multilateration. The determination may be made with assistance from other devices (such as access points or other UEs).

As will be discussed in greater detail below with reference to FIG. 9, UE 901 may determine a relative difference between the reference frames of UE 901 and secondary device 902.

UE 901 may perform an initial calibration. For example, if secondary device 902 remains static for a certain amount of time (e.g., a few seconds), UE 901 can gather baseline position and/or orientation data to determine the static position of secondary device 902. Position and/or orientation data may be obtained in any suitable manner or form, for example, inertial measurement unit (IMU) data from secondary device 902, camera data from secondary device 902, positioning techniques with secondary device 902 as a target device (e.g., TDOA, aspects of the disclosure, mRTT, RTT & AoA), etc. The baseline position and/or orientation data may be provided by the secondary device 902. Additionally or alternatively, as secondary device 902 moves, UE 901 can understand the relative orientations of secondary device 902. For example, the user may perform specific predetermined movements to help generate data that indicates an orientation of secondary device 902.

UE 901 may perform continuous calibration (e.g., after initial calibration). UE 901 may use general trends in position/orientation data over time to align reference frames. Continuous calibration may mitigate the effects of transient movements like head turns or arm swings. UE 901 may regularly (e.g., periodically) synchronize position/orientation data from all secondary devices to correct any drift that may occur over time. For example, The UE can regularly synchronize the IMU data from all secondary devices to correct any drift that may occur over time.

UE 901 may use sensor fusion, pattern recognition, and/or adaptive learning. UE 901 may collect data from multiple sensors (e.g., accelerometer, gyroscope, magnetometer) and/or from multiple devices (e.g., UE 901 and/or one or more secondary devices) and optimally combine them to improve the accuracy of the reference frame alignment. UE 901 may implement machine learning algorithms to help recognize patterns in position and/or orientation data (e.g., sensor data) that corresponds to specific orientations and movements. UE 901 may learn and adapt to the unique movement patterns of a particular user (e.g., over time), thereby improving alignment accuracy.

UE 901 may perform continuous tracking, interactive calibration, and/or error correction. For example, secondary device 902 may provide real-time feedback to UE 901 to ensure accurate alignment. UE 901 may dynamically adjust the alignment if it detects any discrepancies with ranging.

As shown in FIG. 9, UE 901 may travel along a UE path 910. UE path 910 may be defined by a series of positions and/or orientations of UE 901. The series of positions and/or orientations of UE 901 is illustrated as UE path vector 911, UE path vector 912, UE path vector 913, and UE path vector 914. Each UE path vector may be relative to a UE reference frame 931 of UE 901.

Similarly, secondary device 902 may travel along a secondary device path 920. secondary device path 920 may be defined by a series of positions and/or orientations of secondary device 902. The series of positions and/or orientations of secondary device 902 is illustrated as secondary device path vector 921, secondary device path vector 922, secondary device path vector 923, and secondary device path vector 924. Each secondary device path vector may be relative to a secondary device reference frame 932 of secondary device 902.

UE reference frame 931 may have a position and an orientation. For example, in FIG. 9, UE reference frame 931 has an origin (e.g., corresponding to an initial position of UE 901) with three orthogonal axes x1, y1, z1 extending therefrom (e.g., corresponding to an initial orientation of UE 901).

Similarly, secondary device reference frame 932 may have a position and an orientation. The position and orientation of secondary device reference frame 932 may differ from UE reference frame 931. For example, in FIG. 9, secondary device reference frame 932 has an origin (e.g., corresponding to an initial position of secondary device 902) with three orthogonal axes x2, y2, z2 extending therefrom (e.g., corresponding to an initial orientation of secondary device 902).

UE 901 may track the displacement of UE 901 relative to UE reference frame 931. For example, in FIG. 9, UE 901 may determine UE path vector 911 at a first time, UE path vector 912 at a second time, UE path vector 913 at a third time, and UE path vector 914 at a fourth time. As noted above, each UE path vector may be relative to the UE reference frame 931.

Similarly, secondary device 902 may track the displacement of secondary device 902 relative to secondary device reference frame 932. For example, in FIG. 9, secondary device 902 may determine secondary device path vector 921 at the first time, secondary device path vector 922 at the second time, secondary device path vector 923 at the third time, and secondary device path vector 924 at the fourth time. As noted above, each secondary device path vector may be relative to the secondary device reference frame 932.

The tracking performed by UE 901 and/or secondary device 902 may be performed in any suitable manner, for example, using IMU data and/or sensors associated with the device itself, or based on positioning techniques where the device is a target device (e.g., TDOA, aspects of the disclosure, mRTT, RTT & AoA), etc.

The UE 901 and/or secondary device 902 may occasionally (e.g., periodically) measure the relative distance between UE 901 and/or secondary device 902. The distance between UE 901 and secondary device 902 may be measured using, for example, ultra wideband (UWB), Bluetooth channel sounding (BTCS), wireless local area network (WLAN), Wi-Fi, or any combination thereof. For example, in FIG. 9, distance 941 is a distance at the first time, distance 942 is a distance at the second time, distance 943 is a distance at the third time, and distance 944 is a distance at the fourth time. The relative distances may assist the UE 901 and/or secondary device 902 to determine the relationship between UE reference frame 931 and secondary device reference frame 932, so that either device (or both) may know the position of the other device.

The UE 901 and/or secondary device 902 may calculate a reference frame alignment vector 930, which enables either device (or both) to translate position and/or orientation data relative to its own reference frame into position and/or orientation data relative to the other device's reference frame. For example, the reference frame alignment vector 930 may enable UE 901 to determine the position and/or orientation of a target within its own coordinate system (e.g., the UE reference frame 931), and translate the position and/or orientation of the target to the reference frame of the secondary device 902 (e.g., relative to the secondary device reference frame 932).

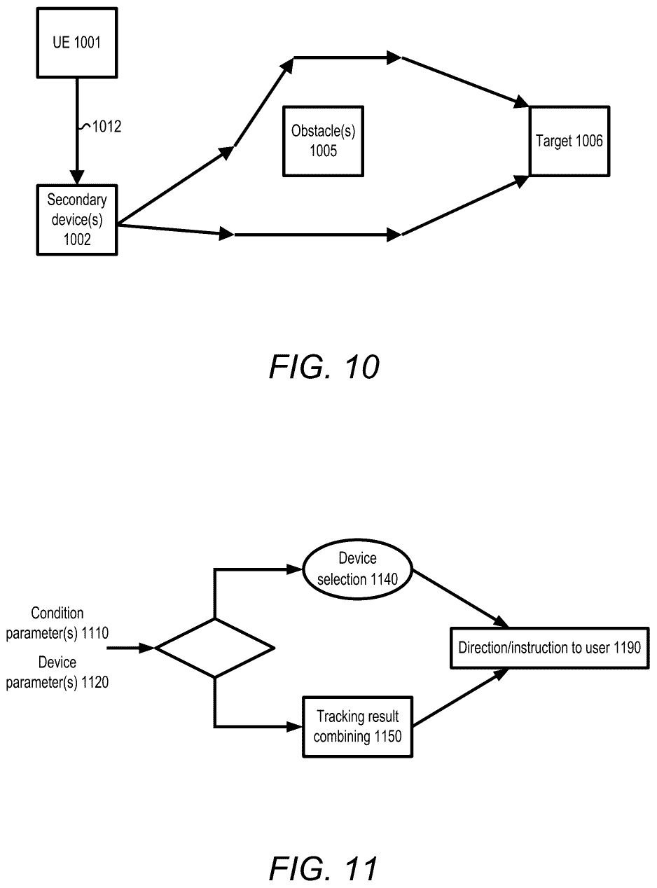

FIG. 10 illustrates an example of instructions and guidance associated with a secondary device, according to aspects of the disclosure. The figure illustrates a UE 1001, one or more secondary devices 1002, an obstacle 1005, and a target 1006. As shown in the figure, UE 1001 may obtain and/or generate a map with directions 1012. UE 1001 may provide the map with directions 1012, or details thereof, with one or more secondary devices 1002. In an example, UE 1001 shares all details of the map with directions 1012 with one or more secondary devices 1002. In another example, UE 1001 shares direction details only. The map with directions 1012 may indicate all possible routes to reach target 1006. The map with directions 1012 may provide sensing information, such as an indication of obstacle 1005.

The map with directions 1012 may serve as an initial reference, allowing the one or more secondary devices 1002 to take over navigation using sensor data obtained and/or generated by the one or more secondary devices 1002. The one or more secondary devices 1002 may provide the user with directions and/or location information related to target 1006. The instructions may be provided to the user in any suitable form, for example, haptic feedback, visual signals, audio cues, or any other method.

As an example of haptic feedback, the one or more secondary devices 1002 may provide the user with left or right-directed vibrations based on the map with directions 1012. For proximity indications, the vibration intensity may increase as the user gets closer to target 1006. For instance, when finding directions, the person may move around, and a stronger vibration may indicate the correct direction. As an example of visual feedback, the one or more secondary devices 1002 may provide the user with blinking different colors for different directions.

FIG. 11 illustrates an example of resource allocation, according to aspects of the disclosure. Once initial ranging is completed, a UE (e.g., UE 601, UE 801, UE 901, UE 1001, or any other UE disclosed herein) may perform dynamic tracking.

As will be discussed in greater detail below, the UE may make one or more decisions based on one or more condition parameters 1110 and/or one or more device parameters 1120. The one or more condition parameters 1110 may include, for example, channel conditions, received signal strength indicator (RSSI), reference signal received power (RSRP), reference signal received quality, or any other indication of channel quality. The channel may be a channel between the UE and the target, between a first secondary device and the target, between a second secondary device and the target, and/or between the UE and the secondary device(s). The one or more device parameters 1120 may include, for example, battery level information, IMU sensor information, camera information, etc. The one or more device parameters 1120 may be specific to a device (e.g., UE, first secondary device, second secondary device, etc.).

The UE may perform device selection 1140 by deciding if the UE should continue to track the target, or if a secondary device (e.g., one or more secondary devices 602, secondary device 802, secondary device 902, one or more secondary devices 1002, or any other secondary device disclosed herein) may take over the tracking. If there is more than one secondary device, then the UE may determine which secondary device may take over the tracking. The device selection 1140 may be based on the one or more condition parameters 1110 and/or the one or more device parameters 1120.

The UE may perform tracking result combining 1150 to enable tracking by multiple devices (e.g., the UE and at least one secondary device). The UE may combine the tracking results of various devices to improve efficiency and/or accuracy. The UE may optimally allocate the resources associated with a particular ranging technique between the UE and the secondary device. For example, the UE may determine and/or receive (e.g., from the secondary device) channel condition information (e.g., information of a channel between the UE and the target, between the secondary device and the target, and/or between the UE and the secondary device). Additionally or alternatively, the UE may determine and/or receive (e.g., from the secondary device) power level information of the target, secondary device, and/or target. Based on any combination of the foregoing, the UE may allocate resources such as bandwidth and power for ranging sessions by the UE and/or secondary device. The tracking result combining 1150 may be based on the one or more condition parameters 1110 and/or the one or more device parameters 1120.

As an example, if the secondary device is subject to power constraints, it may provide the UE with the initial location of the secondary device and a target request. The UE may take over and continuously track the location of both the secondary device and target. In this manner, power consumption can be offloaded to the UE, and resources of the secondary device will be conserved.

The UE may determine a validity parameter (e.g., a duration of validity) associated with a location of a target object. For example, the UE may monitor a length of time since the location has been determined. Based on the length of time exceeding the validity period, the UE and/or secondary device may update the location of the target object.

The UE may determine a frequency of ranging associated with the location of the target object. The frequency of ranging may correspond to the validity period. For example, if the validity period is two seconds, then the UE may determine a frequency of ranging equal to two seconds, in an effort to ensure that the location of the target object is continuously valid. Accordingly, the UE may determine a frequency of ranging for the UE, a frequency of ranging for the secondary device, or both.

In an example, if the secondary device is found to be relatively static (e.g., as determined based on IMU data of the secondary device), the UE may reduce the frequency of ranging (e.g., increase the duration of validity). As another example, if the secondary device is mobile, the UE increases the ranging frequency based on the relative velocity of the secondary device.

In an example, a map (e.g., a map that is generated by the UE and provided to the secondary device) may remain valid as long as the target object is static (e.g., velocity and/or change of position of the target object is/are below a threshold). The UE may periodically track the target object and updates the map if the target object moves.

If the UE and secondary device are both static (e.g., relatively static by comparison to one another, or to a threshold for movement), the UE or the secondary device can track the target object and share the tracked location with the other. For example, if both the UE and the secondary device are carried by the same user (e.g., a person with a watch on wrist and phone in pocket), relative changes between the UE and the secondary device may be negligible, and only arm movements are tracked to align the reference frame. As another example if the user is running with the UE in one hand and watch on the wrist of the other hand, the UE may track the secondary device more frequently. The UE may track the relative dynamic parameters between itself and the secondary device, assisting in the ranging process.

The UE may track the location and provide real-time feedback, or the secondary device can take over the location tracking. If the target is a destination, the UE can simply share the map with the secondary device and provide period updates to the secondary device. These techniques may save power during static scenarios and provide more accurate measurements during mobile scenarios.

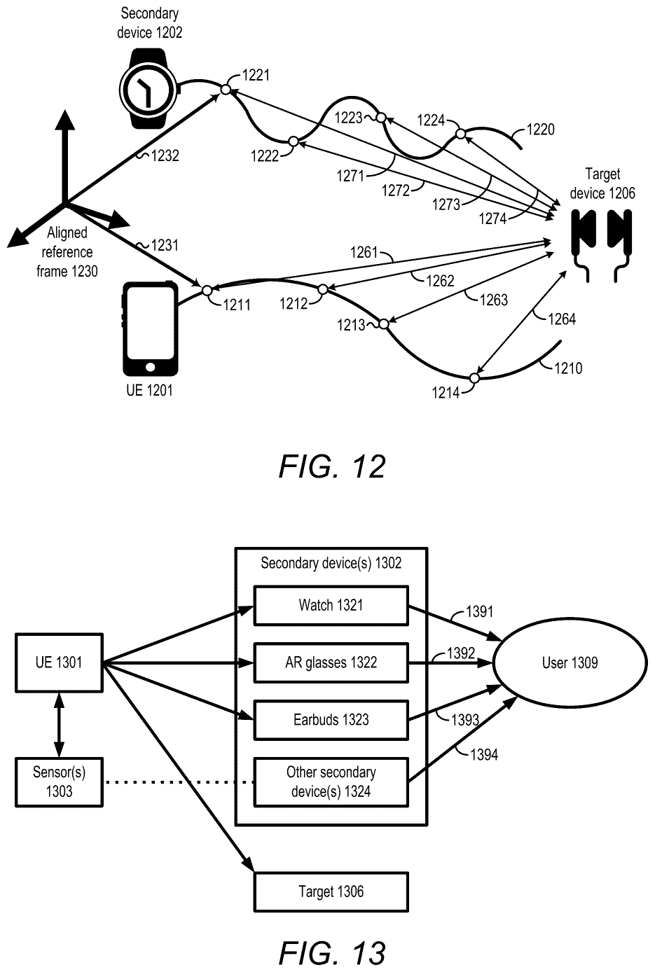

FIG. 12 illustrates an example of combining ranging from multiple devices, according to aspects of the disclosure. The combining of ranging from multiple devices may include selecting an optimal device for ranging (e.g., as described below in the context of FIG. 13). The figure illustrates a UE 1201 and a secondary device 1202. UE 1201 (and/or secondary device 1202) may guide a user to target device 1206, illustrated as a pair of earbuds. UE 1201 follows a UE path 1210 and secondary device 1202 follows a secondary device path 1220. UE 1201 and secondary device 1202 have an aligned reference frame 1230. A UE alignment vector 1231 enables translation of the aligned reference frame 1230 to a reference frame associated with UE 1201. A secondary device alignment vector 1232 enables translation of the aligned reference frame 1230 to a reference frame associated with UE 1201.

The UE path 1210 may be associated with a UE path vector 1211 (e.g., associated with a position and/or orientation of UE 901 at a first time), a UE path vector 1212 (e.g., associated with a position and/or orientation of UE 901 at a second time), a UE path vector 1213 (e.g., associated with a position and/or orientation of UE 901 at a third time), and a UE path vector 1214 (e.g., associated with a position and/or orientation of UE 901 at a fourth time).

Similarly, the secondary device path 1220 may be associated with a secondary device path vector 1221 (e.g., associated with a position and/or orientation of secondary device 902 at the first time), a secondary device path vector 1222 (e.g., associated with a position and/or orientation of secondary device 902 at the second time), a secondary device path vector 1223 (e.g., associated with a position and/or orientation of secondary device 902 at the third time), and a secondary device path vector 1224 (e.g., associated with a position and/or orientation of secondary device 902 at the fourth time).

In an example, multiple devices perform ranging to target device 1206 via multiple radios. At the first time, UE 1201 measures a distance 1261 and secondary device 1202 measures a distance 1271. At the second time, UE 1201 measures a distance 1262 and secondary device 1202 measures a distance 1272. At the third time, UE 1201 measures a distance 1263 and secondary device 1202 measures a distance 1273. At the fourth time, UE 1201 measures a distance 1264 and secondary device 1202 measures a distance 1274.

Combining of distance information (e.g., ranging distance to target device 1206) from both UE 1201 and secondary device 1202 may result in increased spatial resolution, thereby enabling faster location of target device 1206.

FIG. 13 illustrates an example of multi-device tracking, according to aspects of the disclosure. The figure illustrates a UE 1301, one or more secondary devices 1302, one or more sensors 1303, a target 1306, and a user 1309. These may respectively correspond to any of the analogous devices described previously. The one or more secondary devices 1302 comprises a watch 1321, AR glasses 1322, earbuds 1323, and/or one or more other secondary devices 1324.

UE 1301 may track multiple secondary devices (e.g., one or more of 1321, AR glasses 1322, earbuds 1323, and the one or more other secondary devices 1324) in the vicinity, align their respective reference frames, and help simultaneously provide directions to the multiple secondary devices.

UE 1301 may distribute one or more ranging processes across secondary devices based on one or more condition parameters (e.g., channel conditions, RSSI, RSRP, RSRQ, etc.) and/or one or more device parameters (e.g., battery level information, IMU sensor information, camera information, etc.). As noted above, the combining of ranging from multiple devices (e.g., as described below in the context of FIG. 12) may include selecting an optimal device for ranging.

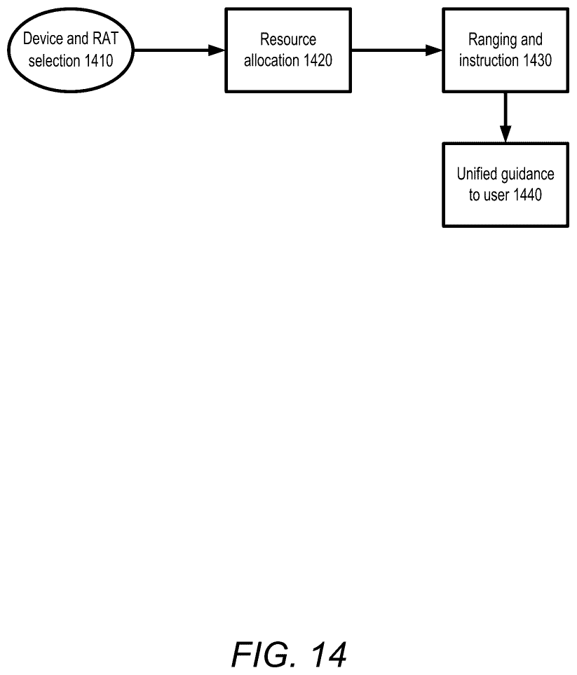

FIG. 14 illustrates an example of optimal and/or efficient allocation of resources, according to aspects of the disclosure.

A UE (e.g., any of the UEs described in the present disclosure) may make use of one or more available metrics to allocate resources. The UE may perform device and RAT selection 1410, resource allocation 1420, and ranging and instruction 1430. The UE may provide unified guidance to user 1440 (e.g., via one or more secondary devices). Resources for locating multiple secondary devices may be allocated by the UE. For instance, the UE may allocate more bandwidth associated with a WLAN (e.g., Wi-Fi) RAT to a distant device for better location accuracy. The UE may allocate less power and/or bandwidth to nearby devices.

When tracking multiple targets, the UE may determine and/or select a secondary device (e.g., a best secondary device) for each target. If multiple RATs are available on a secondary device, the UE may determine and/or select a RAT (e.g., an optimal RAT) for locationing. The UE may all multiple metrics available to itself and the respective secondary devices to allocate resources efficiently. Metrics may relate to channel conditions (e.g., line-of-sight (LOS) or non-line-of-sight (NLOS); multipath rich and/or light scattering; fast or slow fading, etc.), estimated location parameters (e.g., RSSI, range, angle-of-arrival (AoA), angle-of-departure (AoD), etc.), and/or error estimation (e.g., standard deviation, peak-to-peak variation, etc.).

In an example, the UE may perform trigger-based ranging to track multiple devices simultaneously and instruct the secondary device.

In accordance with any of the foregoing examples, a UE (e.g., any of the UEs in the present disclosure) may perform sensor-aided guidance. The UE may sense the environment (e.g., using Wi-Fi sensing) and utilize sensing information within the reference frame of at least one of the one or more secondary devices. The UE may send instructions and directions to the secondary device based on the sensing information. The secondary device may provide feedback to the user (e.g., haptic or visual feedback), enabling multiple applications, as will be discussed in greater detail below.

As an example of obstacle avoidance, in AR applications, haptic feedback may warn users of obstacles in their path. For example, in some scenarios (e.g., a dark room), the UE may sense the environment and direct the user with instructions.

As an example of intrusion alerts, the UE may detect unusual movements or the presence of unauthorized individuals via sensing. The UE may provide an intrusion alert via the secondary device. The secondary device may alert the user via, for example, haptic feedback.

As an example of home automation, the UE may sense changes in a home environment (e.g., temperature, lighting, etc.). The UE may send instructions to the secondary device to adjust settings or alert the user to take action.

As an example of fall detection, the UE may perform wireless sensing to monitor the movements of elderly individuals, detecting falls and sending alerts to caregivers via secondary devices.

As an example of vital signs monitoring, the UE may use wireless signals to monitor vital signs (e.g., heart rate, respiration) and provide real-time health updates to secondary devices.

The UE may perform fusion with locationing. For example, the UE may combine the sensing information with location information and provide combined information to the user via the secondary device, enabling multiple applications, as will be discussed in greater detail below.

As an example of gaming applications, the location of the secondary device (e.g., worn by the user) may be tracked (e.g., with high accuracy). The UE may assist in providing gaming outputs based on the location.

As an example of motion tracking, in industries where there is risk is involved, the UE may track motion and give alerts whenever a user moves in a wrong direction.

In accordance with any of the foregoing examples, a UE and/or secondary device (e.g., any of the UEs and/or secondary devices in the present disclosure) may provide adaptable feedback to a user. Feedback from the secondary device may be dynamically adjusted (e.g., by activating and/or switching a feedback type of the feedback) based on the scenario. The UE may guide the adjustment.

For example, if the secondary device typically provides directions via audio and the UE detects a high auditory volume (e.g., detects a noisy environment), the UE may instruct the secondary device to activate and/or switch to haptic or visual feedback (e.g., so that the user receives clear and effective guidance regardless of the surrounding conditions).

As another example, for a secondary device that provides directions using AR visual feedback, the UE may sense challenges such as poor visibility or user distraction and dynamically activate and/or switch to haptic or audio feedback to maintain effective guidance.

As another example, if there are issues with haptic feedback, such as the user not feeling the vibrations due to thick clothing or high activity levels, the UE may adjust the feedback intensity. Additionally or alternatively, the UE may activate and/or switch to visual or audio feedback.

As another example, if the secondary device has low battery, the UE may switch to a less power-intensive feedback method. For example, the UE may reduce the frequency of haptic feedback or provide fewer visual cues.

As another example, when navigating through a crowded area, the UE may sense the density of the crowd and adjust the feedback on the secondary device to ensure the user receives clear and effective guidance.

In light of the foregoing, directional assistance may enable a primary device (e.g., a UE) to calculate precise locations and send directional information to one or more secondary devices. Reference frame alignment of the secondary device may be continuously tracked (e.g., relative to a target). By selecting a device and RAT for ranging, resources may be allocated efficiently. Multi-device tracking and power save mechanisms are enabled. A unified guidance system may integrate adaptive visual, haptic, and auditory feedback methods to provide comprehensive and effective user guidance. Sensing aided guidance leverages sensing to enhance applications like obstacle avoidance and home automation, providing real-time updates and alerts to secondary devices.

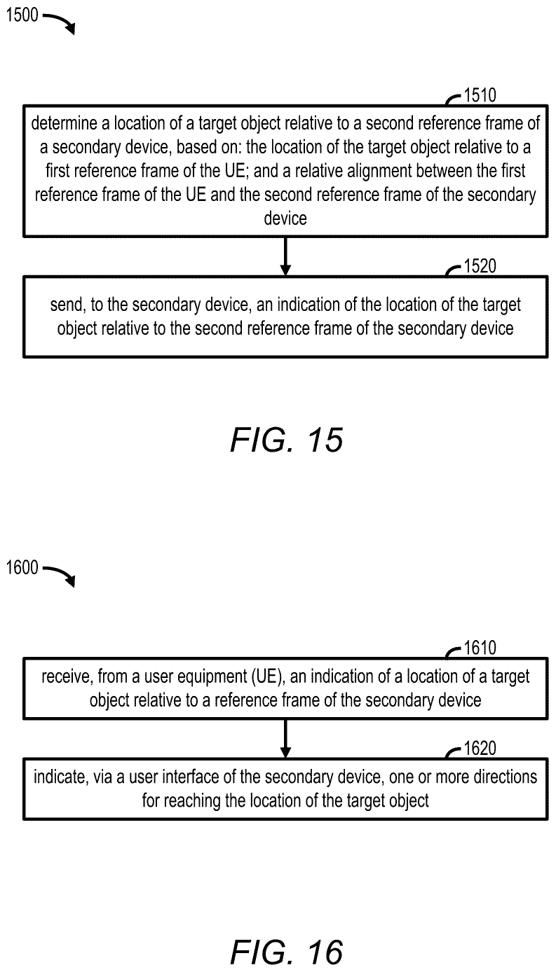

FIG. 15 illustrates an example method 1500 of wireless communication, according to aspects of the disclosure. In an aspect, method 1500 may be performed by a UE (e.g., any of the UEs described herein).

At 1510, the UE determines a location of a target object relative to a second reference frame of a secondary device, based on: the location of the target object relative to a first reference frame of the UE; and a relative alignment between the first reference frame of the UE and the second reference frame of the secondary device.

In an aspect, operation 1510 may be performed by the one or more WWAN transceivers 310, the one or more short-range wireless transceivers 320, the memory 340, the one or more processors 342, and/or the positioning component 348, any or all of which may be considered means for performing this operation.

At 1520, the UE sends, to the secondary device, an indication of the location of the target object relative to the second reference frame of the secondary device.

In an aspect, operation 1520 may be performed by the one or more WWAN transceivers 310, the one or more short-range wireless transceivers 320, the memory 340, the one or more processors 342, and/or the positioning component 348, any or all of which may be considered means for performing this operation.

FIG. 16 illustrates an example method 1600 of wireless communication, according to aspects of the disclosure. In an aspect, method 1600 may be performed by a secondary device (e.g., any of the secondary devices described herein).

At 1610, the secondary device receives, from a user equipment (UE), an indication of a location of a target object relative to a reference frame of the secondary device.

In an aspect, operation 1610 may be performed by the one or more WWAN transceivers 310, the one or more short-range wireless transceivers 320, the memory 340, the one or more processors 342, and/or the positioning component 348, any or all of which may be considered means for performing this operation.

At 1620, the secondary device indicates, via a user interface of the secondary device, one or more directions for reaching the location of the target object.

In an aspect, operation 1620 may be performed by the one or more WWAN transceivers 310, the one or more short-range wireless transceivers 320, the memory 340, the one or more processors 342, and/or the positioning component 348, any or all of which may be considered means for performing this operation.

As will be appreciated, a technical advantage of the method 1500 and the method 1600 is that operations for location-based applications may be offloaded from a secondary device to a primary device (e.g., a device with greater processing power, more battery resources, etc.). Additionally or alternatively, a technical advantage of the method 1500 is that the primary device may aid in ranging and/or both primary and secondary devices may jointly perform ranging.

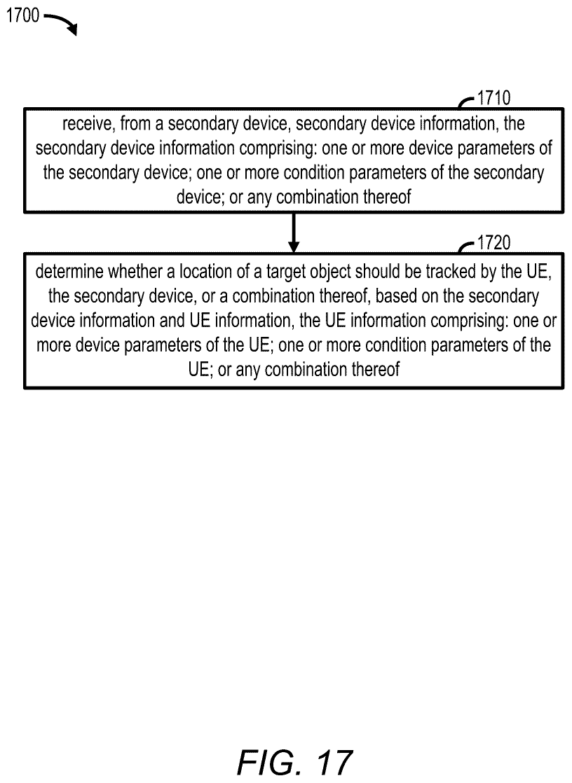

FIG. 17 illustrates an example method 1700 of wireless communication, according to aspects of the disclosure. In an aspect, method 1700 may be performed by a UE (e.g., any of the UEs described herein).

At 1710, the UE receives, from a secondary device, secondary device information, the secondary device information comprising: one or more device parameters of the secondary device; one or more condition parameters of the secondary device; or any combination thereof.

In an aspect, operation 1710 may be performed by the one or more WWAN transceivers 310, the one or more short-range wireless transceivers 320, the memory 340, the one or more processors 342, and/or the positioning component 348, any or all of which may be considered means for performing this operation.

At 1720, the UE determines whether a location of a target object should be tracked by the UE, the secondary device, or a combination thereof, based on the secondary device information and UE information, the UE information comprising: one or more device parameters of the UE; one or more condition parameters of the UE; or any combination thereof.

In an aspect, operation 1720 may be performed by the one or more WWAN transceivers 310, the one or more short-range wireless transceivers 320, the memory 340, the one or more processors 342, and/or the positioning component 348, any or all of which may be considered means for performing this operation.

As will be appreciated, a technical advantage of the method 1700 is that operations for location-based applications may be offloaded from a secondary device to a primary device (e.g., a device with greater processing power, more battery resources, etc.).

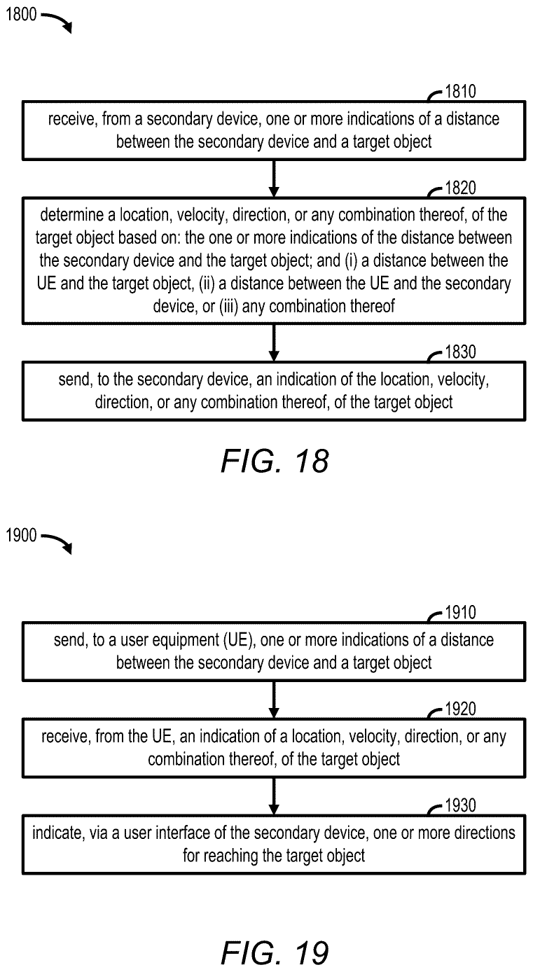

FIG. 18 illustrates an example method 1800 of wireless communication, according to aspects of the disclosure. In an aspect, method 1800 may be performed by a UE (e.g., any of the UEs described herein).

At 1810, the UE receives, from a secondary device, one or more indications of a distance between the secondary device and a target object.

In an aspect, operation 1810 may be performed by the one or more WWAN transceivers 310, the one or more short-range wireless transceivers 320, the memory 340, the one or more processors 342, and/or the positioning component 348, any or all of which may be considered means for performing this operation.

At 1820, the UE determines a location, velocity, direction, or any combination thereof, of the target object based on: the one or more indications of the distance between the secondary device and the target object; and (i) a distance between the UE and the target object, (ii) a distance between the UE and the secondary device, or (iii) any combination thereof.

In an aspect, operation 1820 may be performed by the one or more WWAN transceivers 310, the one or more short-range wireless transceivers 320, the memory 340, the one or more processors 342, and/or the positioning component 348, any or all of which may be considered means for performing this operation.

At 1830, the UE sends, to the secondary device, an indication of the location, velocity, direction, or any combination thereof, of the target object.

In an aspect, operation 1830 may be performed by the one or more WWAN transceivers 310, the one or more short-range wireless transceivers 320, the memory 340, the one or more processors 342, and/or the positioning component 348, any or all of which may be considered means for performing this operation.

FIG. 19 illustrates an example method 1900 of wireless communication, according to aspects of the disclosure. In an aspect, method 1900 may be performed by a secondary device (e.g., any of the secondary devices described herein).

At 1910, the secondary device sends, to a user equipment (UE), one or more indications of a distance between the secondary device and a target object.

In an aspect, operation 1910 may be performed by the one or more WWAN transceivers 310, the one or more short-range wireless transceivers 320, the memory 340, the one or more processors 342, and/or the positioning component 348, any or all of which may be considered means for performing this operation.

At 1920, the secondary device receives, from the UE, an indication of a location, velocity, direction, or any combination thereof, of the target object.

In an aspect, operation 1920 may be performed by the one or more WWAN transceivers 310, the one or more short-range wireless transceivers 320, the memory 340, the one or more processors 342, and/or the positioning component 348, any or all of which may be considered means for performing this operation.

At 1930, the secondary device indicates, via a user interface of the secondary device, one or more directions for reaching the target object.

In an aspect, operation 1930 may be performed by the one or more WWAN transceivers 310, the one or more short-range wireless transceivers 320, the memory 340, the one or more processors 342, and/or the positioning component 348, any or all of which may be considered means for performing this operation.

As will be appreciated, a technical advantage of the method 1800 and the method 1900 is that ranging capabilities of multiple devices may be combined to determine a distance to the target object more accurately and/or more efficiently.

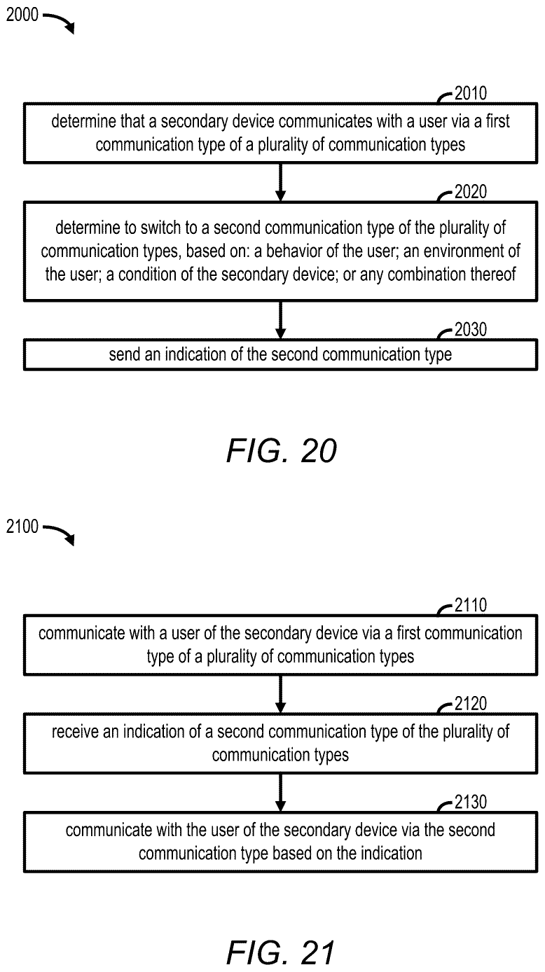

FIG. 20 illustrates an example method 2000 of wireless communication, according to aspects of the disclosure. In an aspect, method 2000 may be performed by a UE (e.g., any of the UEs described herein).

At 2010, the UE determines that a secondary device communicates with a user via a first communication type of a plurality of communication types.

In an aspect, operation 2010 may be performed by the one or more WWAN transceivers 310, the one or more short-range wireless transceivers 320, the memory 340, the one or more processors 342, and/or the positioning component 348, any or all of which may be considered means for performing this operation.

At 2020, the UE determines to switch to a second communication type of the plurality of communication types, based on: a behavior of the user; an environment of the user; a condition of the secondary device; or any combination thereof.

In an aspect, operation 2020 may be performed by the one or more WWAN transceivers 310, the one or more short-range wireless transceivers 320, the memory 340, the one or more processors 342, and/or the positioning component 348, any or all of which may be considered means for performing this operation.

At 2030, the UE sends an indication of the second communication type.

In an aspect, operation 2030 may be performed by the one or more WWAN transceivers 310, the one or more short-range wireless transceivers 320, the memory 340, the one or more processors 342, and/or the positioning component 348, any or all of which may be considered means for performing this operation.

FIG. 21 illustrates an example method 2100 of wireless communication, according to aspects of the disclosure. In an aspect, method 2100 may be performed by a secondary device (e.g., any of the secondary devices described herein).

At 2110, the secondary device communicates with a user of the secondary device via a first communication type of a plurality of communication types.

In an aspect, operation 2110 may be performed by the one or more WWAN transceivers 310, the one or more short-range wireless transceivers 320, the memory 340, the one or more processors 342, and/or the positioning component 348, any or all of which may be considered means for performing this operation.

At 2120, the secondary device receives an indication of a second communication type of the plurality of communication types.

In an aspect, operation 2120 may be performed by the one or more WWAN transceivers 310, the one or more short-range wireless transceivers 320, the memory 340, the one or more processors 342, and/or the positioning component 348, any or all of which may be considered means for performing this operation.

At 2130, the secondary device communicates with the user of the secondary device via the second communication type based on the indication.

In an aspect, operation 2130 may be performed by the one or more WWAN transceivers 310, the one or more short-range wireless transceivers 320, the memory 340, the one or more processors 342, and/or the positioning component 348, any or all of which may be considered means for performing this operation.

As will be appreciated, a technical advantage of the method 2000 and the method 2100 is that a system of complementary devices can communicate with a user more accurately and/or more effectively.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), comprising: determining a location of a target object relative to a second reference frame of a secondary device, based on: the location of the target object relative to a first reference frame of the UE; and a relative alignment between the first reference frame of the UE and the second reference frame of the secondary device; and sending, to the secondary device, an indication of the location of the target object relative to the second reference frame of the secondary device.

Clause 2. The method of clause 1, wherein the location of the target object relative to the first reference frame of the UE is determined based on one or more of: direction and distance detection of the target object; sensing of the target object; inertial measurement unit (IMU) data from an IMU of the UE; acceleration data of the UE; gyroscopic data of the UE; magnetometric data of the UE; visual data from a camera of the UE; or any combination thereof.

Clause 3. The method of any of clauses 1 to 2, further comprising determining the relative alignment between the first reference frame of the UE and the second reference frame of the secondary device based on: the first reference frame of the UE; the second reference frame of the secondary device; absolute coordinates of a location of the UE; absolute coordinates of a location of the secondary device; absolute coordinates of a location of the target object; a distance between the UE and the secondary device; or any combination thereof.

Clause 4. The method of clause 3, further comprising determining the second reference frame of the secondary device based on one or more of: baseline inertial measurement unit (IMU) data obtained while the secondary device is in a static position; IMU data obtained while the secondary device is moving in accordance with a predetermined movement of the secondary device; trend analysis of IMU data obtained over time; synchronization with IMU data obtained by the UE from one or more other secondary devices to correct drift; or any combination thereof.

Clause 5. The method of any of clauses 1 to 4, further comprising updating the relative alignment between the first reference frame of the UE and the second reference frame of the secondary device, wherein the location is determined based on the updated relative alignment.

Clause 6. The method of clause 5, wherein the updating of the relative alignment is based on one or more of: IMU data, acceleration data, gyroscopic data, magnetometric data, or any combination thereof, of the UE; IMU data, acceleration data, gyroscopic data, magnetometric data, or any combination thereof, of the secondary device; direction and distance detection of the target object; and recognition of patterns of relative movement between the UE and the secondary device; recognition of patterns of movement of the user; or any combination thereof.

Clause 7. The method of any of clauses 1 to 6, further comprising receiving, from the secondary device, one or more indications of: absolute coordinates of a location of the secondary device; IMU data, acceleration data, gyroscopic data, magnetometric data, or any combination thereof, of the secondary device; or any combination thereof.

Clause 8. The method of any of clauses 1 to 7, further comprising: determining whether the location of the target object is valid based on one or more validity parameters; updating the location of the target object based on a determination that the location of the target object is not valid; and sending an updated indication of the location of the target object to the secondary device.

Clause 9. The method of clause 8, wherein the one or more validity parameters comprise: an amount of time since the location of the target object was determined; an amount of movement of the UE; an amount of movement of the secondary device; an amount of movement of the target object; or any combination thereof.

Clause 10. The method of any of clauses 1 to 9, wherein the secondary device is one or more of a smartwatch, augmented reality (AR) glasses, a fitness tracker, or any combination thereof.

Clause 11. A user equipment (UE) comprising: one or more memories; one or more transceivers; and one or more processors communicatively coupled to the one or more memories and the one or more transceivers, the one or more processors, either alone or in combination, configured to: determine a location of a target object relative to a second reference frame of a secondary device, based on: the location of the target object relative to a first reference frame of the UE; and a relative alignment between the first reference frame of the UE and the second reference frame of the secondary device; and send, via the one or more transceivers, to the secondary device, an indication of the location of the target object relative to the second reference frame of the secondary device.

Clause 12. The UE of clause 11, wherein the location of the target object relative to the first reference frame of the UE is determined based on one or more of: direction and distance detection of the target object; sensing of the target object; inertial measurement unit (IMU) data from an IMU of the UE; acceleration data of the UE; gyroscopic data of the UE; magnetometric data of the UE; visual data from a camera of the UE; or any combination thereof.

Clause 13. The UE of any of clauses 11 to 12, wherein the one or more processors, either alone or in combination, are further configured to determine the relative alignment between the first reference frame of the UE and the second reference frame of the secondary device based on: the first reference frame of the UE; the second reference frame of the secondary device; absolute coordinates of a location of the UE; absolute coordinates of a location of the secondary device; absolute coordinates of a location of the target object; a distance between the UE and the secondary device; or any combination thereof.

Clause 14. The UE of clause 13, wherein the one or more processors, either alone or in combination, are further configured to determine the second reference frame of the secondary device based on one or more of: baseline inertial measurement unit (IMU) data obtained while the secondary device is in a static position; IMU data obtained while the secondary device is moving in accordance with a predetermined movement of the secondary device; trend analysis of IMU data obtained over time; synchronization with IMU data obtained by the UE from one or more other secondary devices to correct drift; or any combination thereof.

Clause 15. The UE of any of clauses 11 to 14, wherein the one or more processors, either alone or in combination, are further configured to update the relative alignment between the first reference frame of the UE and the second reference frame of the secondary device, wherein the location is determined based on the updated relative alignment.

Clause 16. The UE of clause 15, wherein the updating of the relative alignment is based on one or more of: IMU data, acceleration data, gyroscopic data, magnetometric data, or any combination thereof, of the UE; IMU data, acceleration data, gyroscopic data, magnetometric data, or any combination thereof, of the secondary device; direction and distance detection of the target object; and recognition of patterns of relative movement between the UE and the secondary device; recognition of patterns of movement of the user; or any combination thereof.

Clause 17. The UE of any of clauses 11 to 16, wherein the one or more processors, either alone or in combination, are further configured to receive, via the one or more transceivers, from the secondary device, one or more indications of: absolute coordinates of a location of the secondary device; IMU data, acceleration data, gyroscopic data, magnetometric data, or any combination thereof, of the secondary device; or any combination thereof.

Clause 18. The UE of any of clauses 11 to 17, wherein the one or more processors, either alone or in combination, are further configured to: determine whether the location of the target object is valid based on one or more validity parameters; update the location of the target object based on a determination that the location of the target object is not valid; and send, via the one or more transceivers, an updated indication of the location of the target object to the secondary device.

Clause 19. The UE of clause 18, wherein the one or more validity parameters comprise: an amount of time since the location of the target object was determined; an amount of movement of the UE; an amount of movement of the secondary device; an amount of movement of the target object; or any combination thereof.

Clause 20. The UE of any of clauses 11 to 19, wherein the secondary device is one or more of a smartwatch, augmented reality (AR) glasses, a fitness tracker, or any combination thereof.

Clause 21. A user equipment (UE) comprising: means for determining a location of a target object relative to a second reference frame of a secondary device, based on: the location of the target object relative to a first reference frame of the UE; and a relative alignment between the first reference frame of the UE and the second reference frame of the secondary device; and means for sending, to the secondary device, an indication of the location of the target object relative to the second reference frame of the secondary device.

Clause 22. The UE of clause 21, wherein the location of the target object relative to the first reference frame of the UE is determined based on one or more of: direction and distance detection of the target object; means for sensing of the target object; inertial measurement unit (IMU) data from an IMU of the UE; acceleration data of the UE; gyroscopic data of the UE; magnetometric data of the UE; visual data from a camera of the UE; or any combination thereof.

Clause 23. The UE of any of clauses 21 to 22, further comprising means for determining the relative alignment between the first reference frame of the UE and the second reference frame of the secondary device based on: the first reference frame of the UE; the second reference frame of the secondary device; absolute coordinates of a location of the UE; absolute coordinates of a location of the secondary device; absolute coordinates of a location of the target object; a distance between the UE and the secondary device; or any combination thereof.

Clause 24. The UE of clause 23, further comprising means for determining the second reference frame of the secondary device based on one or more of: baseline inertial measurement unit (IMU) data obtained while the secondary device is in a static position; IMU data obtained while the secondary device is moving in accordance with a predetermined movement of the secondary device; trend analysis of IMU data obtained over time; with IMU data obtained by the UE from one or more other secondary devices to correct drift; or any combination thereof.

Clause 25. The UE of any of clauses 21 to 24, further comprising means for updating the relative alignment between the first reference frame of the UE and the second reference frame of the secondary device, wherein the location is determined based on the updated relative alignment.

Clause 26. The UE of clause 25, wherein the updating of the relative alignment is based on one or more of: IMU data, acceleration data, gyroscopic data, magnetometric data, or any combination thereof, of the UE; IMU data, acceleration data, gyroscopic data, magnetometric data, or any combination thereof, of the secondary device; direction and distance detection of the target object; and recognition of patterns of relative movement between the UE and the secondary device; recognition of patterns of movement of the user; or any combination thereof.

Clause 27. The UE of any of clauses 21 to 26, further comprising means for receiving, from the secondary device, one or more indications of: absolute coordinates of a location of the secondary device; IMU data, acceleration data, gyroscopic data, magnetometric data, or any combination thereof, of the secondary device; or any combination thereof.

Clause 28. The UE of any of clauses 21 to 27, further comprising: means for determining whether the location of the target object is valid based on one or more validity parameters; means for updating the location of the target object based on a determination that the location of the target object is not valid; and means for sending an updated indication of the location of the target object to the secondary device.

Clause 29. The UE of clause 28, wherein the one or more validity parameters comprise: an amount of time since the location of the target object was determined; an amount of movement of the UE; an amount of movement of the secondary device; an amount of movement of the target object; or any combination thereof.

Clause 30. The UE of any of clauses 21 to 29, wherein the secondary device is one or more of a smartwatch, augmented reality (AR) glasses, a fitness tracker, or any combination thereof.

Clause 31. A non-transitory computer-readable medium storing computer-executable instructions that, when executed by a user equipment (UE), cause the UE to: determine a location of a target object relative to a second reference frame of a secondary device, based on: the location of the target object relative to a first reference frame of the UE; and a relative alignment between the first reference frame of the UE and the second reference frame of the secondary device; and send, to the secondary device, an indication of the location of the target object relative to the second reference frame of the secondary device.

Clause 32. The non-transitory computer-readable medium of clause 31, wherein the location of the target object relative to the first reference frame of the UE is determined based on one or more of: direction and distance detection of the target object; sensing of the target object; inertial measurement unit (IMU) data from an IMU of the UE; acceleration data of the UE; gyroscopic data of the UE; magnetometric data of the UE; visual data from a camera of the UE; or any combination thereof.

Clause 33. The non-transitory computer-readable medium of any of clauses 31 to 32, further comprising computer-executable instructions that, when executed by the UE, cause the UE to determine the relative alignment between the first reference frame of the UE and the second reference frame of the secondary device based on: the first reference frame of the UE; the second reference frame of the secondary device; absolute coordinates of a location of the UE; absolute coordinates of a location of the secondary device; absolute coordinates of a location of the target object; a distance between the UE and the secondary device; or any combination thereof.

Clause 34. The non-transitory computer-readable medium of clause 33, further comprising computer-executable instructions that, when executed by the UE, cause the UE to determine the second reference frame of the secondary device based on one or more of: baseline inertial measurement unit (IMU) data obtained while the secondary device is in a static position; IMU data obtained while the secondary device is moving in accordance with a predetermined movement of the secondary device; trend analysis of IMU data obtained over time; with IMU data obtained by the UE from one or more other secondary devices to correct drift; or any combination thereof.

Clause 35. The non-transitory computer-readable medium of any of clauses 31 to 34, further comprising computer-executable instructions that, when executed by the UE, cause the UE to update the relative alignment between the first reference frame of the UE and the second reference frame of the secondary device, wherein the location is determined based on the updated relative alignment.

Clause 36. The non-transitory computer-readable medium of clause 35, wherein the updating of the relative alignment is based on one or more of: IMU data, acceleration data, gyroscopic data, magnetometric data, or any combination thereof, of the UE; IMU data, acceleration data, gyroscopic data, magnetometric data, or any combination thereof, of the secondary device; direction and distance detection of the target object; and recognition of patterns of relative movement between the UE and the secondary device; recognition of patterns of movement of the user; or any combination thereof.

Clause 37. The non-transitory computer-readable medium of any of clauses 31 to 36, further comprising computer-executable instructions that, when executed by the UE, cause the UE to receive, from the secondary device, one or more indications of: absolute coordinates of a location of the secondary device; IMU data, acceleration data, gyroscopic data, magnetometric data, or any combination thereof, of the secondary device; or any combination thereof.

Clause 38. The non-transitory computer-readable medium of any of clauses 31 to 37, further comprising computer-executable instructions that, when executed by the UE, cause the UE to: determine whether the location of the target object is valid based on one or more validity parameters; update the location of the target object based on a determination that the location of the target object is not valid; and send an updated indication of the location of the target object to the secondary device.

Clause 39. The non-transitory computer-readable medium of clause 38, wherein the one or more validity parameters comprise: an amount of time since the location of the target object was determined; an amount of movement of the UE; an amount of movement of the secondary device; an amount of movement of the target object; or any combination thereof.

Clause 40. The non-transitory computer-readable medium of any of clauses 31 to 39, wherein the secondary device is one or more of a smartwatch, augmented reality (AR) glasses, a fitness tracker, or any combination thereof.

Clause 41. A method of wireless communication performed by a secondary device, comprising: receiving, from a user equipment (UE), an indication of a location of a target object relative to a reference frame of the secondary device; and indicating, via a user interface of the secondary device, one or more directions for reaching the location of the target object.

Clause 42. The method of clause 41, wherein the indication of the location of the target object relative to the reference frame of the secondary device is received from the UE in a message comprising: a map comprising the location of the target object; the one or more directions for reaching the location of the target object; a plurality of different sets of directions comprising the one or more directions; an indication of a location of at least one obstacle relative to a reference frame of the secondary device; or any combination thereof.

Clause 43. The method of any of clauses 41 to 42, wherein the user interface of the secondary device is associated with audio communication, visual communication, haptic communication, or any combination thereof.

Clause 44. The method of clause 43, wherein: the user interface of the secondary device is associated with visual communication; a first color associated with the visual communication indicates a first direction; and a second color associated with the visual communication indicates a second direction different from the first direction.

Clause 45. The method of any of clauses 43 to 44, wherein: the user interface of the secondary device is associated with haptic communication; a first vibration intensity associated with the haptic communication indicates a first distance from the target object; and a second vibration intensity associated with the haptic communication indicates a second distance from the target object different from the first distance.

Clause 46. The method of any of clauses 41 to 45, wherein the secondary device is one or more of a smartwatch, augmented reality (AR) glasses, a fitness tracker, one or more headphones, one or more earphones, or any combination thereof.

Clause 47. A secondary device comprising: one or more memories; one or more transceivers; and one or more processors communicatively coupled to the one or more memories and the one or more transceivers, the one or more processors, either alone or in combination, configured to: receive, via the one or more transceivers, from a user equipment (UE), an indication of a location of a target object relative to a reference frame of the secondary device; and indicate, via a user interface of the secondary device, one or more directions for reaching the location of the target object.

Clause 48. The secondary device of clause 47, wherein the indication of the location of the target object relative to the reference frame of the secondary device is received from the UE in a message comprising: a map comprising the location of the target object; the one or more directions for reaching the location of the target object; a plurality of different sets of directions comprising the one or more directions; an indication of a location of at least one obstacle relative to a reference frame of the secondary device; or any combination thereof.

Clause 49. The secondary device of any of clauses 47 to 48, wherein the user interface of the secondary device is associated with audio communication, visual communication, haptic communication, or any combination thereof.

Clause 50. The secondary device of clause 49, wherein: the user interface of the secondary device is associated with visual communication; a first color associated with the visual communication indicates a first direction; and a second color associated with the visual communication indicates a second direction different from the first direction.

Clause 51. The secondary device of any of clauses 49 to 50, wherein: the user interface of the secondary device is associated with haptic communication; a first vibration intensity associated with the haptic communication indicates a first distance from the target object; and a second vibration intensity associated with the haptic communication indicates a second distance from the target object different from the first distance.

Clause 52. The secondary device of any of clauses 47 to 51, wherein the secondary device is one or more of a smartwatch, augmented reality (AR) glasses, a fitness tracker, one or more headphones, one or more earphones, or any combination thereof.

Clause 53. A secondary device comprising: means for receiving, from a user equipment (UE), an indication of a location of a target object relative to a reference frame of the secondary device; and means for indicating, via a user interface of the secondary device, one or more directions for reaching the location of the target object.

Clause 54. The secondary device of clause 53, wherein the indication of the location of the target object relative to the reference frame of the secondary device is received from the UE in a message comprising: a map comprising the location of the target object; the one or more directions for reaching the location of the target object; a plurality of different sets of directions comprising the one or more directions; an indication of a location of at least one obstacle relative to a reference frame of the secondary device; or any combination thereof.

Clause 55. The secondary device of any of clauses 53 to 54, wherein the user interface of the secondary device is associated with audio communication, visual communication, haptic communication, or any combination thereof.

Clause 56. The secondary device of clause 55, wherein: the user interface of the secondary device is associated with visual communication; a first color associated with the visual communication indicates a first direction; and a second color associated with the visual communication indicates a second direction different from the first direction.

Clause 57. The secondary device of any of clauses 55 to 56, wherein: the user interface of the secondary device is associated with haptic communication; a first vibration intensity associated with the haptic communication indicates a first distance from the target object; and a second vibration intensity associated with the haptic communication indicates a second distance from the target object different from the first distance.

Clause 58. The secondary device of any of clauses 53 to 57, wherein the secondary device is one or more of a smartwatch, augmented reality (AR) glasses, a fitness tracker, one or more headphones, one or more earphones, or any combination thereof.

Clause 59. A non-transitory computer-readable medium storing computer-executable instructions that, when executed by a secondary device, cause the secondary device to: receive, from a user equipment (UE), an indication of a location of a target object relative to a reference frame of the secondary device; and indicate, via a user interface of the secondary device, one or more directions for reaching the location of the target object.

Clause 60. The non-transitory computer-readable medium of clause 59, wherein the indication of the location of the target object relative to the reference frame of the secondary device is received from the UE in a message comprising: a map comprising the location of the target object; the one or more directions for reaching the location of the target object; a plurality of different sets of directions comprising the one or more directions; an indication of a location of at least one obstacle relative to a reference frame of the secondary device; or any combination thereof.

Clause 61. The non-transitory computer-readable medium of any of clauses 59 to 60, wherein the user interface of the secondary device is associated with audio communication, visual communication, haptic communication, or any combination thereof.

Clause 62. The non-transitory computer-readable medium of clause 61, wherein: the user interface of the secondary device is associated with visual communication; a first color associated with the visual communication indicates a first direction; and a second color associated with the visual communication indicates a second direction different from the first direction.

Clause 63. The non-transitory computer-readable medium of any of clauses 61 to 62, wherein: the user interface of the secondary device is associated with haptic communication; a first vibration intensity associated with the haptic communication indicates a first distance from the target object; and a second vibration intensity associated with the haptic communication indicates a second distance from the target object different from the first distance.

Clause 64. The non-transitory computer-readable medium of any of clauses 59 to 63, wherein the secondary device is one or more of a smartwatch, augmented reality (AR) glasses, a fitness tracker, one or more headphones, one or more earphones, or any combination thereof.

Clause 65. A method of wireless communication performed by a user equipment (UE), comprising: receiving, from a secondary device, secondary device information, the secondary device information comprising: one or more device parameters of the secondary device; one or more condition parameters of the secondary device; or any combination thereof; and determining whether a location of a target object should be tracked by the UE, the secondary device, or a combination thereof, based on the secondary device information and UE information, the UE information comprising: one or more device parameters of the UE; one or more condition parameters of the UE; or any combination thereof.

Clause 66. The method of clause 65, wherein the one or more device parameters of the secondary device are associated with: a power level of the secondary device; a sensor available to the secondary device; a radio access technology (RAT) available to the secondary device; or any combination thereof.

Clause 67. The method of any of clauses 65 to 66, wherein the one or more device parameters of the UE are associated with: a power level of the UE; a sensor available to the UE; a radio access technology (RAT) available to the UE; or any combination thereof.

Clause 68. The method of any of clauses 65 to 67, wherein the one or more condition parameters of the secondary device are associated with: a channel condition of a channel between the secondary device and the target object; a channel condition of a channel between the UE and the secondary device; a signal strength or signal quality of a signal that is transmitted by the target object and received by the secondary device; or any combination thereof.

Clause 69. The method of any of clauses 65 to 68, wherein the one or more condition parameters of the UE are associated with: a channel condition of a channel between the UE and the target object; a signal strength or signal quality of a signal that is transmitted by the target object and received by the UE; or any combination thereof.

Clause 70. The method of any of clauses 65 to 69, further comprising: receiving, from a second secondary device different from the secondary device, second secondary device information, the second secondary device information comprising: one or more device parameters of the second secondary device; one or more condition parameters of the second secondary device; or any combination thereof; determining whether the location of the target object should be tracked by the UE, the secondary device, the second secondary device, or a combination thereof, based on the secondary device information, the second secondary device information, and the UE information.

Clause 71. A user equipment (UE) comprising: one or more memories; one or more transceivers; and one or more processors communicatively coupled to the one or more memories and the one or more transceivers, the one or more processors, either alone or in combination, configured to: receive, via the one or more transceivers, from a secondary device, secondary device information, the secondary device information comprising: one or more device parameters of the secondary device; one or more condition parameters of the secondary device; or any combination thereof; and determine whether a location of a target object should be tracked by the UE, the secondary device, or a combination thereof, based on the secondary device information and UE information, the UE information comprising: one or more device parameters of the UE; one or more condition parameters of the UE; or any combination thereof.

Clause 72. The UE of clause 71, wherein the one or more device parameters of the secondary device are associated with: a power level of the secondary device; a sensor available to the secondary device; a radio access technology (RAT) available to the secondary device; or any combination thereof.

Clause 73. The UE of any of clauses 71 to 72, wherein the one or more device parameters of the UE are associated with: a power level of the UE; a sensor available to the UE; a radio access technology (RAT) available to the UE; or any combination thereof.

Clause 74. The UE of any of clauses 71 to 73, wherein the one or more condition parameters of the secondary device are associated with: a channel condition of a channel between the secondary device and the target object; a channel condition of a channel between the UE and the secondary device; a signal strength or signal quality of a signal that is transmitted by the target object and received by the secondary device; or any combination thereof.

Clause 75. The UE of any of clauses 71 to 74, wherein the one or more condition parameters of the UE are associated with: a channel condition of a channel between the UE and the target object; a signal strength or signal quality of a signal that is transmitted by the target object and received by the UE; or any combination thereof.

Clause 76. The UE of any of clauses 71 to 75, wherein the one or more processors, either alone or in combination, are further configured to: receive, via the one or more transceivers, from a second secondary device different from the secondary device, second secondary device information, the second secondary device information comprising: one or more device parameters of the second secondary device; one or more condition parameters of the second secondary device; or any combination thereof; determine whether the location of the target object should be tracked by the UE, the secondary device, the second secondary device, or a combination thereof, based on the secondary device information, the second secondary device information, and the UE information.

Clause 77. A user equipment (UE) comprising: means for receiving, from a secondary device, secondary device information, the secondary device information comprising: one or more device parameters of the secondary device; one or more condition parameters of the secondary device; or any combination thereof; and means for determining whether a location of a target object should be tracked by the UE, the secondary device, or a combination thereof, based on the secondary device information and UE information, the UE information comprising: one or more device parameters of the UE; one or more condition parameters of the UE; or any combination thereof.

Clause 78. The UE of clause 77, wherein the one or more device parameters of the secondary device are associated with: a power level of the secondary device; a sensor available to the secondary device; a radio access technology (RAT) available to the secondary device; or any combination thereof.

Clause 79. The UE of any of clauses 77 to 78, wherein the one or more device parameters of the UE are associated with: a power level of the UE; a sensor available to the UE; a radio access technology (RAT) available to the UE; or any combination thereof.

Clause 80. The UE of any of clauses 77 to 79, wherein the one or more condition parameters of the secondary device are associated with: a channel condition of a channel between the secondary device and the target object; a channel condition of a channel between the UE and the secondary device; a signal strength or signal quality of a signal that is transmitted by the target object and received by the secondary device; or any combination thereof.

Clause 81. The UE of any of clauses 77 to 80, wherein the one or more condition parameters of the UE are associated with: a channel condition of a channel between the UE and the target object; a signal strength or signal quality of a signal that is transmitted by the target object and received by the UE; or any combination thereof.

Clause 82. The UE of any of clauses 77 to 81, further comprising: means for receiving, from a second secondary device different from the secondary device, second secondary device information, the second secondary device information comprising: one or more device parameters of the second secondary device; one or more condition parameters of the second secondary device; or any combination thereof; means for determining whether the location of the target object should be tracked by the UE, the secondary device, the second secondary device, or a combination thereof, based on the secondary device information, the second secondary device information, and the UE information.

Clause 83. A non-transitory computer-readable medium storing computer-executable instructions that, when executed by a user equipment (UE), cause the UE to: receive, from a secondary device, secondary device information, the secondary device information comprising: one or more device parameters of the secondary device; one or more condition parameters of the secondary device; or any combination thereof; and determine whether a location of a target object should be tracked by the UE, the secondary device, or a combination thereof, based on the secondary device information and UE information, the UE information comprising: one or more device parameters of the UE; one or more condition parameters of the UE; or any combination thereof.

Clause 84. The non-transitory computer-readable medium of clause 83, wherein the one or more device parameters of the secondary device are associated with: a power level of the secondary device; a sensor available to the secondary device; a radio access technology (RAT) available to the secondary device; or any combination thereof.

Clause 85. The non-transitory computer-readable medium of any of clauses 83 to 84, wherein the one or more device parameters of the UE are associated with: a power level of the UE; a sensor available to the UE; a radio access technology (RAT) available to the UE; or any combination thereof.

Clause 86. The non-transitory computer-readable medium of any of clauses 83 to 85, wherein the one or more condition parameters of the secondary device are associated with: a channel condition of a channel between the secondary device and the target object; a channel condition of a channel between the UE and the secondary device; a signal strength or signal quality of a signal that is transmitted by the target object and received by the secondary device; or any combination thereof.

Clause 87. The non-transitory computer-readable medium of any of clauses 83 to 86, wherein the one or more condition parameters of the UE are associated with: a channel condition of a channel between the UE and the target object; a signal strength or signal quality of a signal that is transmitted by the target object and received by the UE; or any combination thereof.

Clause 88. The non-transitory computer-readable medium of any of clauses 83 to 87, further comprising computer-executable instructions that, when executed by the UE, cause the UE to: receive, from a second secondary device different from the secondary device, second secondary device information, the second secondary device information comprising: one or more device parameters of the second secondary device; one or more condition parameters of the second secondary device; or any combination thereof; determine whether the location of the target object should be tracked by the UE, the secondary device, the second secondary device, or a combination thereof, based on the secondary device information, the second secondary device information, and the UE information.

Clause 89. A method of wireless communication performed by a user equipment (UE), comprising: receiving, from a secondary device, one or more indications of a distance between the secondary device and a target object; determining a location, velocity, direction, or any combination thereof, of the target object based on: the one or more indications of the distance between the secondary device and the target object; and (i) a distance between the UE and the target object, (ii) a distance between the UE and the secondary device, or (iii) any combination thereof; and sending, to the secondary device, an indication of the location, velocity, direction, or any combination thereof, of the target object.

Clause 90. The method of clause 89, further comprising determining a relative alignment between a first reference frame of the UE and a second reference frame of the secondary device, wherein the indication of the location, velocity, direction, or any combination thereof, of the target object is relative to the second reference frame of a secondary device.

Clause 91. A user equipment (UE) comprising: one or more memories; one or more transceivers; and one or more processors communicatively coupled to the one or more memories and the one or more transceivers, the one or more processors, either alone or in combination, configured to: receive, via the one or more transceivers, from a secondary device, one or more indications of a distance between the secondary device and a target object; determine a location, velocity, direction, or any combination thereof, of the target object based on: the one or more indications of the distance between the secondary device and the target object; and (i) a distance between the UE and the target object, (ii) a distance between the UE and the secondary device, or (iii) any combination thereof; and send, via the one or more transceivers, to the secondary device, an indication of the location, velocity, direction, or any combination thereof, of the target object.

Clause 92. The UE of clause 91, wherein the one or more processors, either alone or in combination, are further configured to determine a relative alignment between a first reference frame of the UE and a second reference frame of the secondary device, wherein the indication of the location, velocity, direction, or any combination thereof, of the target object is relative to the second reference frame of a secondary device.

Clause 93. A user equipment (UE) comprising: means for receiving, from a secondary device, one or more indications of a distance between the secondary device and a target object; means for determining a location, velocity, direction, or any combination thereof, of the target object based on: the one or more indications of the distance between the secondary device and the target object; and (i) a distance between the UE and the target object, (ii) a distance between the UE and the secondary device, or (iii) any combination thereof; and means for sending, to the secondary device, an indication of the location, velocity, direction, or any combination thereof, of the target object.

Clause 94. The UE of clause 93, further comprising means for determining a relative alignment between a first reference frame of the UE and a second reference frame of the secondary device, wherein the indication of the location, velocity, direction, or any combination thereof, of the target object is relative to the second reference frame of a secondary device.

Clause 95. A non-transitory computer-readable medium storing computer-executable instructions that, when executed by a user equipment (UE), cause the UE to: receive, from a secondary device, one or more indications of a distance between the secondary device and a target object; determine a location, velocity, direction, or any combination thereof, of the target object based on: the one or more indications of the distance between the secondary device and the target object; and (i) a distance between the UE and the target object, (ii) a distance between the UE and the secondary device, or (iii) any combination thereof; and send, to the secondary device, an indication of the location, velocity, direction, or any combination thereof, of the target object.

Clause 96. The non-transitory computer-readable medium of clause 95, further comprising computer-executable instructions that, when executed by the UE, cause the UE to determine a relative alignment between a first reference frame of the UE and a second reference frame of the secondary device, wherein the indication of the location, velocity, direction, or any combination thereof, of the target object is relative to the second reference frame of a secondary device.

Clause 97. A method of wireless communication performed by a secondary device, comprising: sending, to a user equipment (UE), one or more indications of a distance between the secondary device and a target object; and receiving, from the UE, an indication of a location, velocity, direction, or any combination thereof, of the target object; indicating, via a user interface of the secondary device, one or more directions for reaching the target object.

Clause 98. The method of clause 97, wherein the indication of the location, velocity, direction, or any combination thereof, of the target object is received from the UE in a message comprising: a map comprising the location of the target object; the one or more directions for reaching the location of the target object; a plurality of different sets of directions comprising the one or more directions; an indication of a location of at least one obstacle relative to a reference frame of the secondary device; or any combination thereof.

Clause 99. The method of any of clauses 97 to 98, wherein the user interface of the secondary device is associated with audio communication, visual communication, haptic communication, or any combination thereof.

Clause 100. The method of any of clauses 97 to 99, wherein the location, velocity, direction, or any combination thereof received from the UE are based on a reference frame of the secondary device.

Clause 101. The method of any of clauses 97 to 100, wherein the user interface of the secondary device is associated with a plurality of communication types, the one or more communication types comprising audio communication, visual communication, haptic communication, or any combination thereof.

Clause 102. The method of any of clauses 97 to 101, further comprising: indicating at least one first direction of the one or more directions for reaching the target object using a first communication type of a plurality of communication types associated with the user interface of the secondary device; receiving, from the UE, an indication of a second communication type of the plurality of communication types; and indicating, via the user interface of the secondary device, at least one second direction of the one or more directions using the second communication type, based on the indication of the second communication type.

Clause 103. A secondary device comprising: one or more memories; one or more transceivers; and one or more processors communicatively coupled to the one or more memories and the one or more transceivers, the one or more processors, either alone or in combination, configured to: send, via the one or more transceivers, to a user equipment (UE), one or more indications of a distance between the secondary device and a target object; and receive, via the one or more transceivers, from the UE, an indication of a location, velocity, direction, or any combination thereof, of the target object; indicate, via a user interface of the secondary device, one or more directions for reaching the target object.

Clause 104. The secondary device of clause 103, wherein the indication of the location, velocity, direction, or any combination thereof, of the target object is received from the UE in a message comprising: a map comprising the location of the target object; the one or more directions for reaching the location of the target object; a plurality of different sets of directions comprising the one or more directions; an indication of a location of at least one obstacle relative to a reference frame of the secondary device; or any combination thereof.

Clause 105. The secondary device of any of clauses 103 to 104, wherein the user interface of the secondary device is associated with audio communication, visual communication, haptic communication, or any combination thereof.

Clause 106. The secondary device of any of clauses 103 to 105, wherein the location, velocity, direction, or any combination thereof received from the UE are based on a reference frame of the secondary device.

Clause 107. The secondary device of any of clauses 103 to 106, wherein the user interface of the secondary device is associated with a plurality of communication types, the one or more communication types comprising audio communication, visual communication, haptic communication, or any combination thereof.

Clause 108. The secondary device of any of clauses 103 to 107, wherein the one or more processors, either alone or in combination, are further configured to: indicate at least one first direction of the one or more directions for reaching the target object using a first communication type of a plurality of communication types associated with the user interface of the secondary device; receive, via the one or more transceivers, from the UE, an indication of a second communication type of the plurality of communication types; and indicate, via the user interface of the secondary device, at least one second direction of the one or more directions using the second communication type, based on the indication of the second communication type.

Clause 109. A secondary device comprising: means for sending, to a user equipment (UE), one or more indications of a distance between the secondary device and a target object; and means for receiving, from the UE, an indication of a location, velocity, direction, or any combination thereof, of the target object; means for indicating, via a user interface of the secondary device, one or more directions for reaching the target object.

Clause 110. The secondary device of clause 109, wherein the indication of the location, velocity, direction, or any combination thereof, of the target object is received from the UE in a message comprising: a map comprising the location of the target object; the one or more directions for reaching the location of the target object; a plurality of different sets of directions comprising the one or more directions; an indication of a location of at least one obstacle relative to a reference frame of the secondary device; or any combination thereof.

Clause 111. The secondary device of any of clauses 109 to 110, wherein the user interface of the secondary device is associated with audio communication, visual communication, haptic communication, or any combination thereof.

Clause 112. The secondary device of any of clauses 109 to 111, wherein the location, velocity, direction, or any combination thereof received from the UE are based on a reference frame of the secondary device.

Clause 113. The secondary device of any of clauses 109 to 112, wherein the user interface of the secondary device is associated with a plurality of communication types, the one or more communication types comprising audio communication, visual communication, haptic communication, or any combination thereof.

Clause 114. The secondary device of any of clauses 109 to 113, further comprising: means for indicating at least one first direction of the one or more directions for reaching the target object using a first communication type of a plurality of communication types associated with the user interface of the secondary device; means for receiving, from the UE, an indication of a second communication type of the plurality of communication types; and means for indicating, via the user interface of the secondary device, at least one second direction of the one or more directions using the second communication type, based on the indication of the second communication type.

Clause 115. A non-transitory computer-readable medium storing computer-executable instructions that, when executed by a secondary device, cause the secondary device to: send, to a user equipment (UE), one or more indications of a distance between the secondary device and a target object; and receive, from the UE, an indication of a location, velocity, direction, or any combination thereof, of the target object; indicate, via a user interface of the secondary device, one or more directions for reaching the target object.

Clause 116. The non-transitory computer-readable medium of clause 115, wherein the indication of the location, velocity, direction, or any combination thereof, of the target object is received from the UE in a message comprising: a map comprising the location of the target object; the one or more directions for reaching the location of the target object; a plurality of different sets of directions comprising the one or more directions; an indication of a location of at least one obstacle relative to a reference frame of the secondary device; or any combination thereof.

Clause 117. The non-transitory computer-readable medium of any of clauses 115 to 116, wherein the user interface of the secondary device is associated with audio communication, visual communication, haptic communication, or any combination thereof.

Clause 118. The non-transitory computer-readable medium of any of clauses 115 to 117, wherein the location, velocity, direction, or any combination thereof received from the UE are based on a reference frame of the secondary device.

Clause 119. The non-transitory computer-readable medium of any of clauses 115 to 118, wherein the user interface of the secondary device is associated with a plurality of communication types, the one or more communication types comprising audio communication, visual communication, haptic communication, or any combination thereof.

Clause 120. The non-transitory computer-readable medium of any of clauses 115 to 119, further comprising computer-executable instructions that, when executed by the secondary device, cause the secondary device to: indicate at least one first direction of the one or more directions for reaching the target object using a first communication type of a plurality of communication types associated with the user interface of the secondary device; receive, from the UE, an indication of a second communication type of the plurality of communication types; and indicate, via the user interface of the secondary device, at least one second direction of the one or more directions using the second communication type, based on the indication of the second communication type.

Clause 121. A method of wireless communication performed by a user equipment (UE), comprising: sensing an environment of the UE to obtain sensing information; and sending instructions, directions, or any combination thereof to a secondary device based on the sensing information.

Clause 122. A method of wireless communication performed by a user equipment (UE), comprising: determining that a secondary device communicates with a user via a first communication type of a plurality of communication types; determining to switch to a second communication type of the plurality of communication types, based on: a behavior of the user; an environment of the user; a condition of the secondary device; or any combination thereof; and sending an indication of the second communication type.

Clause 123. The method of clause 122, wherein the plurality of communication types comprise: audio communication; visual communication; haptic communication; or any combination thereof.

Clause 124. The method of any of clauses 122 to 123, further comprising receiving, from the secondary device, an indication that the secondary device communicates with the user via the first communication type.

Clause 125. The method of any of clauses 122 to 124, wherein: the first communication type is audio communication; determining to switch to the second communication type is based on a determination by the UE that auditory noise in the environment of the user exceeds an auditory noise threshold; and the second communication type is visual communication or haptic communication.

Clause 126. The method of any of clauses 122 to 125, wherein: the first communication type is visual communication; determining to switch to the second communication type is based on a determination by the UE that the behavior of the user is associated with distraction; and the second communication type is audio communication or haptic communication.

Clause 127. The method of any of clauses 122 to 126, wherein: the first communication type is haptic communication having a first intensity; determining to switch to the second communication type is based on a determination by the UE that the behavior of the user is associated with insensitivity; and the second communication type is haptic communication having a second intensity higher than the first intensity, audio communication, or visual communication.

Clause 128. The method of any of clauses 122 to 127, wherein: the first communication type is associated with a first rate of power consumption; determining to switch to the second communication type is based on a determination by the UE that the condition of the secondary device is associated with low power; and the second communication type is associated with a second rate of power consumption lower than the first rate of power consumption.

Clause 129. The method of any of clauses 122 to 128, wherein: the secondary device is associated with a plurality of communication types, including the first communication type and the second communication type; and the indication is sent to the secondary device.

Clause 130. The method of any of clauses 122 to 129, wherein the secondary device is a first secondary device of a plurality of secondary devices, and the indication is sent to a second secondary device, different from the first secondary device, based on: the first secondary device being not associated with the second communication type; the second secondary device being associated with the second communication type; or any combination thereof.

Clause 131. A user equipment (UE) comprising: one or more memories; one or more transceivers; and one or more processors communicatively coupled to the one or more memories and the one or more transceivers, the one or more processors, either alone or in combination, configured to: sense an environment of the UE to obtain sensing information; and send, via the one or more transceivers, instructions, directions, or any combination thereof to a secondary device based on the sensing information.

Clause 132. A user equipment (UE) comprising: one or more memories; one or more transceivers; and one or more processors communicatively coupled to the one or more memories and the one or more transceivers, the one or more processors, either alone or in combination, configured to: determine that a secondary device communicates with a user via a first communication type of a plurality of communication types; determine to switch to a second communication type of the plurality of communication types, based on: a behavior of the user; an environment of the user; a condition of the secondary device; or any combination thereof; and send, via the one or more transceivers, an indication of the second communication type.

Clause 133. The UE of clause 132, wherein the plurality of communication types comprise: audio communication; visual communication; haptic communication; or any combination thereof.

Clause 134. The UE of any of clauses 132 to 133, wherein the one or more processors, either alone or in combination, are further configured to receive, via the one or more transceivers, from the secondary device, an indication that the secondary device communicates with the user via the first communication type.

Clause 135. The UE of any of clauses 132 to 134, wherein: the first communication type is audio communication; determine to switch to the second communication type is based on a determination by the UE that auditory noise in the environment of the user exceeds an auditory noise threshold; and the second communication type is visual communication or haptic communication.

Clause 136. The UE of any of clauses 132 to 135, wherein: the first communication type is visual communication; determine to switch to the second communication type is based on a determination by the UE that the behavior of the user is associated with distraction; and the second communication type is audio communication or haptic communication.

Clause 137. The UE of any of clauses 132 to 136, wherein: the first communication type is haptic communication having a first intensity; determine to switch to the second communication type is based on a determination by the UE that the behavior of the user is associated with insensitivity; and the second communication type is haptic communication having a second intensity higher than the first intensity, audio communication, or visual communication.

Clause 138. The UE of any of clauses 132 to 137, wherein: the first communication type is associated with a first rate of power consumption; determine to switch to the second communication type is based on a determination by the UE that the condition of the secondary device is associated with low power; and the second communication type is associated with a second rate of power consumption lower than the first rate of power consumption.

Clause 139. The UE of any of clauses 132 to 138, wherein: the secondary device is associated with a plurality of communication types, including the first communication type and the second communication type; and the indication is sent to the secondary device.

Clause 140. The UE of any of clauses 132 to 139, wherein the secondary device is a first secondary device of a plurality of secondary devices, and the indication is sent to a second secondary device, different from the first secondary device, based on: the first secondary device being not associated with the second communication type; the second secondary device being associated with the second communication type; or any combination thereof.

Clause 141. A user equipment (UE) comprising: means for sensing an environment of the UE to obtain sensing information; and means for sending instructions, directions, or any combination thereof to a secondary device based on the sensing information.

Clause 142. A user equipment (UE) comprising: means for determining that a secondary device communicates with a user via a first communication type of a plurality of communication types; means for determining to switch to a second communication type of the plurality of communication types, based on: a behavior of the user; an environment of the user; a condition of the secondary device; or any combination thereof; and means for sending an indication of the second communication type.

Clause 143. The UE of clause 142, wherein the plurality of communication types comprise: audio communication; visual communication; haptic communication; or any combination thereof.

Clause 144. The UE of any of clauses 142 to 143, further comprising means for receiving, from the secondary device, an indication that the secondary device communicates with the user via the first communication type.

Clause 145. The UE of any of clauses 142 to 144, wherein: the first communication type is audio communication; means for determining to switch to the second communication type is based on a determination by the UE that auditory noise in the environment of the user exceeds an auditory noise threshold; and the second communication type is visual communication or haptic communication.

Clause 146. The UE of any of clauses 142 to 145, wherein: the first communication type is visual communication; means for determining to switch to the second communication type is based on a determination by the UE that the behavior of the user is associated with distraction; and the second communication type is audio communication or haptic communication.

Clause 147. The UE of any of clauses 142 to 146, wherein: the first communication type is haptic communication having a first intensity; means for determining to switch to the second communication type is based on a determination by the UE that the behavior of the user is associated with insensitivity; and the second communication type is haptic communication having a second intensity higher than the first intensity, audio communication, or visual communication.

Clause 148. The UE of any of clauses 142 to 147, wherein: the first communication type is associated with a first rate of power consumption; means for determining to switch to the second communication type is based on a determination by the UE that the condition of the secondary device is associated with low power; and the second communication type is associated with a second rate of power consumption lower than the first rate of power consumption.

Clause 149. The UE of any of clauses 142 to 148, wherein: the secondary device is associated with a plurality of communication types, including the first communication type and the second communication type; and the indication is sent to the secondary device.

Clause 150. The UE of any of clauses 142 to 149, wherein the secondary device is a first secondary device of a plurality of secondary devices, and the indication is sent to a second secondary device, different from the first secondary device, based on: the first secondary device being not associated with the second communication type; the second secondary device being associated with the second communication type; or any combination thereof.

Clause 151. A non-transitory computer-readable medium storing computer-executable instructions that, when executed by a user equipment (UE), cause the UE to: sense an environment of the UE to obtain sensing information; and send instructions, directions, or any combination thereof to a secondary device based on the sensing information.

Clause 152. A non-transitory computer-readable medium storing computer-executable instructions that, when executed by a user equipment (UE), cause the UE to: determine that a secondary device communicates with a user via a first communication type of a plurality of communication types; determine to switch to a second communication type of the plurality of communication types, based on: a behavior of the user; an environment of the user; a condition of the secondary device; or any combination thereof; and send an indication of the second communication type.

Clause 153. The non-transitory computer-readable medium of clause 152, wherein the plurality of communication types comprise: audio communication; visual communication; haptic communication; or any combination thereof.

Clause 154. The non-transitory computer-readable medium of any of clauses 152 to 153, further comprising computer-executable instructions that, when executed by the UE, cause the UE to receive, from the secondary device, an indication that the secondary device communicates with the user via the first communication type.

Clause 155. The non-transitory computer-readable medium of any of clauses 152 to 154, wherein: the first communication type is audio communication; determine to switch to the second communication type is based on a determination by the UE that auditory noise in the environment of the user exceeds an auditory noise threshold; and the second communication type is visual communication or haptic communication.

Clause 156. The non-transitory computer-readable medium of any of clauses 152 to 155, wherein: the first communication type is visual communication; determine to switch to the second communication type is based on a determination by the UE that the behavior of the user is associated with distraction; and the second communication type is audio communication or haptic communication.

Clause 157. The non-transitory computer-readable medium of any of clauses 152 to 156, wherein: the first communication type is haptic communication having a first intensity; determine to switch to the second communication type is based on a determination by the UE that the behavior of the user is associated with insensitivity; and the second communication type is haptic communication having a second intensity higher than the first intensity, audio communication, or visual communication.

Clause 158. The non-transitory computer-readable medium of any of clauses 152 to 157, wherein: the first communication type is associated with a first rate of power consumption; determine to switch to the second communication type is based on a determination by the UE that the condition of the secondary device is associated with low power; and the second communication type is associated with a second rate of power consumption lower than the first rate of power consumption.

Clause 159. The non-transitory computer-readable medium of any of clauses 152 to 158, wherein: the secondary device is associated with a plurality of communication types, including the first communication type and the second communication type; and the indication is sent to the secondary device.

Clause 160. The non-transitory computer-readable medium of any of clauses 152 to 159, wherein the secondary device is a first secondary device of a plurality of secondary devices, and the indication is sent to a second secondary device, different from the first secondary device, based on: the first secondary device being not associated with the second communication type; the second secondary device being associated with the second communication type; or any combination thereof.

Clause 161. A method of wireless communication performed by a secondary device, comprising: communicating with a user of the secondary device via a first communication type of a plurality of communication types; receiving an indication of a second communication type of the plurality of communication types; and communicating with the user of the secondary device via the second communication type based on the indication.

Clause 162. A secondary device comprising: one or more memories; one or more transceivers; and one or more processors communicatively coupled to the one or more memories and the one or more transceivers, the one or more processors, either alone or in combination, configured to: communicate with a user of the secondary device via a first communication type of a plurality of communication types; receive, via the one or more transceivers, an indication of a second communication type of the plurality of communication types; and communicate with the user of the secondary device via the second communication type based on the indication.

Clause 163. A secondary device comprising: means for communicating with a user of the secondary device via a first communication type of a plurality of communication types; means for receiving an indication of a second communication type of the plurality of communication types; and means for communicating with the user of the secondary device via the second communication type based on the indication.

Clause 164. A non-transitory computer-readable medium storing computer-executable instructions that, when executed by a secondary device, cause the secondary device to: communicate with a user of the secondary device via a first communication type of a plurality of communication types; receive an indication of a second communication type of the plurality of communication types; and communicate with the user of the secondary device via the second communication type based on the indication.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A user equipment (UE) comprising:
one or more memories;
one or more transceivers; and
one or more processors communicatively coupled to the one or more memories and the one or more transceivers, the one or more processors, either alone or in combination, configured to:
determine a location of a target object relative to a second reference frame of a secondary device, based on:
the location of the target object relative to a first reference frame of the UE; and
a relative alignment between the first reference frame of the UE and the second reference frame of the secondary device; and
send, via the one or more transceivers, to the secondary device, an indication of the location of the target object relative to the second reference frame of the secondary device.

2. The UE of claim 1, wherein the location of the target object relative to the first reference frame of the UE is determined based on one or more of:
direction and distance detection of the target object;
sensing of the target object;
inertial measurement unit (IMU) data from an IMU of the UE;
acceleration data of the UE;
gyroscopic data of the UE;
magnetometric data of the UE;
visual data from a camera of the UE; or
any combination thereof.

3. The UE of claim 1, wherein the one or more processors, either alone or in combination, are further configured to determine the relative alignment between the first reference frame of the UE and the second reference frame of the secondary device based on:
the first reference frame of the UE;
the second reference frame of the secondary device;
absolute coordinates of a location of the UE;
absolute coordinates of a location of the secondary device;
absolute coordinates of a location of the target object;
a distance between the UE and the secondary device; or
any combination thereof.

4. The UE of claim 3, wherein the one or more processors, either alone or in combination, are further configured to determine the second reference frame of the secondary device based on one or more of:
baseline inertial measurement unit (IMU) data obtained while the secondary device is in a static position;
IMU data obtained while the secondary device is moving in accordance with a predetermined movement of the secondary device;
trend analysis of IMU data obtained over time;
synchronization with IMU data obtained by the UE from one or more other secondary devices to correct drift; or
any combination thereof.

5. The UE of claim 1, wherein the one or more processors, either alone or in combination, are further configured to update the relative alignment between the first reference frame of the UE and the second reference frame of the secondary device, wherein the location is determined based on the updated relative alignment.

6. The UE of claim 5, wherein the updating of the relative alignment is based on one or more of:
IMU data, acceleration data, gyroscopic data, magnetometric data, or any combination thereof, of the UE;
IMU data, acceleration data, gyroscopic data, magnetometric data, or any combination thereof, of the secondary device;
direction and distance detection of the target object; and
recognition of patterns of relative movement between the UE and the secondary device;
recognition of patterns of movement of the user; or
any combination thereof.

7. The UE of claim 1, wherein the one or more processors, either alone or in combination, are further configured to receive, via the one or more transceivers, from the secondary device, one or more indications of:
absolute coordinates of a location of the secondary device;
IMU data, acceleration data, gyroscopic data, magnetometric data, or any combination thereof, of the secondary device; or
any combination thereof.

8. The UE of claim 1, wherein the one or more processors, either alone or in combination, are further configured to:
determine whether the location of the target object is valid based on one or more validity parameters;
update the location of the target object based on a determination that the location of the target object is not valid; and
send, via the one or more transceivers, an updated indication of the location of the target object to the secondary device.

9. The UE of claim 8, wherein the one or more validity parameters comprise:
an amount of time since the location of the target object was determined;
an amount of movement of the UE;
an amount of movement of the secondary device;
an amount of movement of the target object; or
any combination thereof.

10. The UE of claim 1, wherein the secondary device is one or more of a smartwatch, augmented reality (AR) glasses, a fitness tracker, or any combination thereof.

11. A method of wireless communication performed by a user equipment (UE), comprising:
determining a location of a target object relative to a second reference frame of a secondary device, based on:
the location of the target object relative to a first reference frame of the UE; and
a relative alignment between the first reference frame of the UE and the second reference frame of the secondary device; and
sending, to the secondary device, an indication of the location of the target object relative to the second reference frame of the secondary device.

12. The method of claim 11, wherein the location of the target object relative to the first reference frame of the UE is determined based on one or more of:
direction and distance detection of the target object;
sensing of the target object;
inertial measurement unit (IMU) data from an IMU of the UE;
acceleration data of the UE;
gyroscopic data of the UE;
magnetometric data of the UE;
visual data from a camera of the UE; or
any combination thereof.

13. The method of claim 11, further comprising determining the relative alignment between the first reference frame of the UE and the second reference frame of the secondary device based on:
the first reference frame of the UE;
the second reference frame of the secondary device;
absolute coordinates of a location of the UE;
absolute coordinates of a location of the secondary device;
absolute coordinates of a location of the target object;
a distance between the UE and the secondary device; or
any combination thereof.

14. The method of claim 13, further comprising determining the second reference frame of the secondary device based on one or more of:
baseline inertial measurement unit (IMU) data obtained while the secondary device is in a static position;
IMU data obtained while the secondary device is moving in accordance with a predetermined movement of the secondary device;
trend analysis of IMU data obtained over time;
synchronization with IMU data obtained by the UE from one or more other secondary devices to correct drift; or
any combination thereof.

15. The method of claim 11, further comprising updating the relative alignment between the first reference frame of the UE and the second reference frame of the secondary device, wherein the location is determined based on the updated relative alignment.

16. The method of claim 11, further comprising receiving, from the secondary device, one or more indications of:
absolute coordinates of a location of the secondary device;
IMU data, acceleration data, gyroscopic data, magnetometric data, or any combination thereof, of the secondary device; or
any combination thereof.

17. A user equipment (UE) comprising:
one or more memories;
one or more transceivers; and
one or more processors communicatively coupled to the one or more memories and the one or more transceivers, the one or more processors, either alone or in combination, configured to:
receive, via the one or more transceivers, from a secondary device, secondary device information, the secondary device information comprising:
one or more device parameters of the secondary device;
one or more condition parameters of the secondary device; or
any combination thereof; and
determine whether a location of a target object should be tracked by the UE, the secondary device, or a combination thereof, based on the secondary device information and UE information, the UE information comprising:
one or more device parameters of the UE;
one or more condition parameters of the UE; or
any combination thereof.

18. The UE of claim 17, wherein the one or more device parameters of the secondary device are associated with:
a power level of the secondary device;
a sensor available to the secondary device;
a radio access technology (RAT) available to the secondary device; or
any combination thereof.

19. The UE of claim 17, wherein the one or more device parameters of the UE are associated with:
a power level of the UE;
a sensor available to the UE;
a radio access technology (RAT) available to the UE; or
any combination thereof.

20. The UE of claim 17, wherein the one or more condition parameters of the secondary device are associated with:
a channel condition of a channel between the secondary device and the target object;
a channel condition of a channel between the UE and the secondary device;
a signal strength or signal quality of a signal that is transmitted by the target object and received by the secondary device; or
any combination thereof.

21. The UE of claim 17, wherein the one or more condition parameters of the UE are associated with:
a channel condition of a channel between the UE and the target object;
a signal strength or signal quality of a signal that is transmitted by the target object and received by the UE; or
any combination thereof.

22. The UE of claim 17, wherein the one or more processors, either alone or in combination, are further configured to:
receive, via the one or more transceivers, from a second secondary device different from the secondary device, second secondary device information, the second secondary device information comprising:
one or more device parameters of the second secondary device;
one or more condition parameters of the second secondary device;
or any combination thereof;
determine whether the location of the target object should be tracked by the UE, the secondary device, the second secondary device, or a combination thereof, based on the secondary device information, the second secondary device information, and the UE information.

23. A method of wireless communication performed by a user equipment (UE), comprising:
receiving, from a secondary device, secondary device information, the secondary device information comprising:
one or more device parameters of the secondary device;
one or more condition parameters of the secondary device; or
any combination thereof; and
determining whether a location of a target object should be tracked by the UE, the secondary device, or a combination thereof, based on the secondary device information and UE information, the UE information comprising:
one or more device parameters of the UE;
one or more condition parameters of the UE; or
any combination thereof.

24. The method of claim 23, wherein the one or more device parameters of the secondary device are associated with:
a power level of the secondary device;
a sensor available to the secondary device;
a radio access technology (RAT) available to the secondary device; or
any combination thereof.

25. The method of claim 23, wherein the one or more device parameters of the UE are associated with:
a power level of the UE;
a sensor available to the UE;
a radio access technology (RAT) available to the UE; or
any combination thereof.

26. The method of claim 23, wherein the one or more condition parameters of the secondary device are associated with:
a channel condition of a channel between the secondary device and the target object;
a channel condition of a channel between the UE and the secondary device;
a signal strength or signal quality of a signal that is transmitted by the target object and received by the secondary device; or
any combination thereof.

27. The method of claim 23, wherein the one or more condition parameters of the UE are associated with:
a channel condition of a channel between the UE and the target object;
a signal strength or signal quality of a signal that is transmitted by the target object and received by the UE; or
any combination thereof.

28. A user equipment (UE) comprising:
one or more memories;
one or more transceivers; and
one or more processors communicatively coupled to the one or more memories and the one or more transceivers, the one or more processors, either alone or in combination, configured to:
determine that a secondary device communicates with a user via a first communication type of a plurality of communication types;
determine to switch to a second communication type of the plurality of communication types, based on:
a behavior of the user;
an environment of the user;
a condition of the secondary device; or
any combination thereof; and
send, via the one or more transceivers, an indication of the second communication type.

29. The UE of claim 28, wherein the plurality of communication types comprise:
audio communication;
visual communication;
haptic communication; or
any combination thereof.

30. The UE of claim 28, wherein the one or more processors, either alone or in combination, are further configured to receive, via the one or more transceivers, from the secondary device, an indication that the secondary device communicates with the user via the first communication type.

31. The UE of claim 28, wherein:
the first communication type is audio communication;
determine to switch to the second communication type is based on a determination by the UE that auditory noise in the environment of the user exceeds an auditory noise threshold; and
the second communication type is visual communication or haptic communication.

32. The UE of claim 28, wherein:
the first communication type is visual communication;
determine to switch to the second communication type is based on a determination by the UE that the behavior of the user is associated with distraction; and
the second communication type is audio communication or haptic communication.

33. The UE of claim 28, wherein:
the first communication type is haptic communication having a first intensity;
determine to switch to the second communication type is based on a determination by the UE that the behavior of the user is associated with insensitivity; and
the second communication type is haptic communication having a second intensity higher than the first intensity, audio communication, or visual communication.

34. The UE of claim 28, wherein:
the first communication type is associated with a first rate of power consumption;
determine to switch to the second communication type is based on a determination by the UE that the condition of the secondary device is associated with low power; and
the second communication type is associated with a second rate of power consumption lower than the first rate of power consumption.

35. The UE of claim 28, wherein:
the secondary device is associated with a plurality of communication types, including the first communication type and the second communication type; and
the indication is sent to the secondary device.

36. The UE of claim 28, wherein the secondary device is a first secondary device of a plurality of secondary devices, and the indication is sent to a second secondary device, different from the first secondary device, based on:
the first secondary device being not associated with the second communication type;
the second secondary device being associated with the second communication type; or
any combination thereof.

37. A method of wireless communication performed by a user equipment (UE), comprising:
determining that a secondary device communicates with a user via a first communication type of a plurality of communication types;
determining to switch to a second communication type of the plurality of communication types, based on:
a behavior of the user;
an environment of the user;
a condition of the secondary device; or
any combination thereof; and
sending an indication of the second communication type.

38. The method of claim 37, wherein the plurality of communication types comprise:
audio communication;
visual communication;
haptic communication; or
any combination thereof.

39. The method of claim 37, further comprising receiving, from the secondary device, an indication that the secondary device communicates with the user via the first communication type.

40. The method of claim 37, wherein:
the first communication type is audio communication;
determining to switch to the second communication type is based on a determination by the UE that auditory noise in the environment of the user exceeds an auditory noise threshold; and
the second communication type is visual communication or haptic communication.

41. The method of claim 37, wherein:
the first communication type is visual communication;
determining to switch to the second communication type is based on a determination by the UE that the behavior of the user is associated with distraction; and
the second communication type is audio communication or haptic communication.

42. The method of claim 37, wherein:
the first communication type is haptic communication having a first intensity;
determining to switch to the second communication type is based on a determination by the UE that the behavior of the user is associated with insensitivity; and
the second communication type is haptic communication having a second intensity higher than the first intensity, audio communication, or visual communication.

43. The method of claim 37, wherein:
the first communication type is associated with a first rate of power consumption;
determining to switch to the second communication type is based on a determination by the UE that the condition of the secondary device is associated with low power; and
the second communication type is associated with a second rate of power consumption lower than the first rate of power consumption.
